(19) United States
(12) Patent Application Publication
(10) Pub. No.: US 2026/0118238 A1
(43) Pub. Date: Apr. 30, 2026

(54) CHARACTERIZATION AND DETECTION OF ACCELERATION-INDUCED CAVITATION IN SOFT MATTERS USING A DROP-TOWER-BASED REPETITIVE IMPACT SYSTEM

(71) Applicants: Chunghwan KIM, Tempe, AZ (US); Maxwell KULAK, Mesa, AZ (US); Wonmo KANG, Chandler, AZ (US)

(72) Inventors: Chunghwan KIM, Tempe, AZ (US); Maxwell KULAK, Mesa, AZ (US); Wonmo KANG, Chandler, AZ (US)

(73) Assignee: Arizona Board of Regents on Behalf of Arizona State University, Scottsdale, AZ (US)

(21) Appl. No.: 19/367,562

(22) Filed: Oct. 23, 2025

Related U.S. Application Data
(60) Provisional application No. 63/711,565, filed on Oct. 24, 2024.

(51) Int. Cl. G01N 3/303; G01N 3/34

(52) U.S. Cl. CPC G01N 3/303; G01N 3/34; G01N 2203/0007; G01N 2203/0033; G01N 2203/0092; G01N 2203/026; G01N 2203/0605

(57) ABSTRACT

A repetitive impact system is disclosed for testing soft material samples under controlled impact conditions. The system includes a drop tower with a moveable mass that is repeatedly lifted and dropped by a motor-driven rack and pinion mechanism. The pinion gear may be configured to fail before other components. A sample holder is positioned in the path of the mass and may contain foam and rubber layers on one or both surfaces. An accelerometer may detect horizontal acceleration exceeding a threshold, triggering a camera to capture images for cavitation analysis. The system may apply smooth acceleration trajectories and allow adjustment of impact height based on gear tooth configuration. A method is also disclosed for detecting initial cavitation nucleation by monitoring acceleration values during repeated impacts. This system enables precise, repeatable testing of soft materials and supports real-time detection of cavitation events.

### RELATED APPLICATIONS

This application claims the benefit of U.S. provisional patent application 63/711,565, filed Oct. 24, 2024, to Kim, et al., titled “CHARACTERIZATION AND DETECTION OF ACCELERATION-INDUCED CAVITATION IN SOFT MATTERS USING A DROP-TOWER-BASED REPETITIVE IMPACT SYSTEM,” the entirety of the disclosure of which is hereby incorporated by this reference.

### STATEMENT REGARDING FEDERALLY SPONSORED RESEARCH OR DEVELOPMENT

This invention was made with government support under N00014-20-1-2409 awarded by the Office of Naval Research. The government has certain rights in the invention.

### TECHNICAL FIELD

This document relates to a process for characterization and detection of acceleration-induced cavitation in soft matters using a drop tower-based repetitive impact system.

### BACKGROUND

Soft materials, comprising a variety of classes of substances such as polymer, elastomers, hydrogels, and foam, play a crucial role in the field of biomedical engineering and biomaterial development including artificial organ (e.g., cartridge and hip implant), wound healing process, tissue regeneration, as well as stretchable soft bioelectronics for human skin surface. Their unique mechanical properties, i.e., flexibility, viscoelasticity, high deformability, and recovery characteristics, make them indispensable by replacing and/or mimicking a native tissue.

### SUMMARY

According to some embodiments, a repetitive impact system comprises a drop tower having a moveable mass configured to move in a vertical direction with respect to the drop tower, a sample holder configured to contain a soft material sample, the sample holder positioned in a path of travel of the moveable mass with respect to the drop tower, wherein the sample holder has a foam material and a rubber material layered on both a bottom surface and a top surface of the sample holder, and a motor system configured to repeatedly lift the moveable mass, the motor system comprising a motor configured to rotate at a constant rate, a rack attached to and configured to move with the moveable mass, wherein the rack has a plurality of teeth, and a pinion gear attached to the motor, the pinion gear having at least one crescent with at least one tooth, wherein when the motor rotates, the pinion gear rotates such that the at least one crescent circles about the motor, wherein the pinion gear is positioned to allow the at least one tooth of the at least one crescent to interface with the plurality of teeth of the rack when the at least one crescent is closest to the rack, and wherein when the at least one tooth of the at least one crescent interfaces with the plurality of teeth of the rack, the pinion gear is configured to lift the rack and the moveable mass up to a desired height and drop the rack and the moveable mass to impact the sample holder.

Particular embodiments may comprise one or more of the following features. The system may further comprise an accelerometer in contact with the sample holder, the accelerometer configured to detect an acceleration value of the sample holder in a horizontal direction perpendicular to the vertical direction, and a camera configured to take an image of the sample holder in response to detection of the acceleration value of the sample holder rising above a threshold acceleration value. The rubber material may comprise a silicone rubber sheet. The system may be configured to apply rapid and smooth acceleration trajectories to the soft material sample. The desired height may be dependent on a number of teeth in the at least one tooth on the pinion gear. The pinion gear may be a partial gear. The pinion gear may be configured to fail before other components of the repetitive impact system. The sample holder may be aligned with the moveable mass of the drop tower.

According to some embodiments, a repetitive impact system comprises a drop tower having a moveable mass configured to move in a vertical direction with respect to the drop tower, a sample holder positioned in a path of travel of the moveable mass with respect to the drop tower, and a motor system configured to repeatedly lift the moveable mass, the motor system comprising a motor configured to rotate, a rack attached to and configured to move with the moveable mass, wherein the rack has a plurality of teeth, and a pinion gear attached to the motor and positioned to periodically engage with the plurality of teeth of the rack, and wherein when the pinion gear engages with the plurality of teeth of the rack, the pinion gear is configured to lift the rack and the moveable mass up to a desired height and drop the rack and the moveable mass to impact the sample holder.

Particular embodiments may comprise one or more of the following features. The sample holder may be configured to contain a soft material sample. The sample holder may have a foam material and a rubber material layered on at least one of a bottom surface and a top surface of the sample holder. The motor may rotate at a constant rate. The pinion gear may have at least one crescent with at least one tooth, wherein when the motor rotates, the pinion gear rotates such that the at least one crescent circles about the motor, and wherein the at least one tooth of the at least one crescent are configured to interface with the plurality of teeth of the rack when the at least one crescent is closest to the rack. The system may further comprise an accelerometer in contact with the sample holder, the accelerometer configured to detect an acceleration value of the sample holder in a horizontal direction perpendicular to the vertical direction, and a camera configured to take an image of the sample holder in response to detection of the acceleration value of the sample holder rising above a threshold acceleration value. The desired height may be dependent on a number of teeth on the pinion gear.

According to some embodiments, a method for detection of initial cavitation nucleation while applying repeated impacts comprises providing a sample holder configured to contain a soft material sample, positioning an accelerometer in contact with the sample holder, impacting the sample holder repeatedly with a moveable mass moving in a first direction, selecting a threshold acceleration value for the accelerometer in a second direction perpendicular to the first direction, and detecting, with the accelerometer, initial cavitation nucleation within the soft material sample by detecting an acceleration value higher than the threshold acceleration value.

Particular embodiments may comprise one or more of the following features. The method may further comprise taking an image of the sample holder with a camera in response to detecting the acceleration with the value higher than the threshold acceleration value. The method may further comprise repeatedly lifting the moveable mass with a motor and dropping the moveable mass on the sample holder. The method may further comprise providing a pinion gear attached to the motor to lift the moveable mass. The method may further comprise configuring the pinion gear to fail before other components involved in the repeated impacts.

The foregoing and other aspects, features, and advantages will be apparent from the DESCRIPTION and DRAWINGS, and from the CLAIMS if any are included.

### BRIEF DESCRIPTION OF THE DRAWINGS

Implementations will hereinafter be described in conjunction with the appended and/or included DRAWINGS, where like designations denote like elements.

FIG. 1A is a schematic side view of a repetitive impact system for soft material samples according to some embodiments.

FIG. 1B is a schematic of a sample holder of a repetitive impact system connected with data acquisition according to some embodiments.

FIG. 1C is a front view of a repetitive impact system according to some embodiments.

FIG. 2 is a table of summarized gear design parameters for a repetitive impact system according to some embodiments.

FIG. 3 is a table of re-slip, slip, and drop height for different numbers of gear teeth along a single arc or crescent of a repetitive impact system according to some embodiments.

FIG. 4A shows measured acceleration profiles for different gear designs with a silicone rubber sheet thickness of T₂=2 mm according to some embodiments.

FIG. 4B shows measured acceleration profiles for different gear designs with a silicone rubber sheet thickness of T₂=3 mm. aₘᵢₙ, aₘₐₓ, and Δt represent minimum and maximum accelerations and the time interval between them.

FIG. 4C shows the average maximum and minimum accelerations (i.e., āₘₐₓ and āₘᵢₙ) and time intervals (Δt̅) between āₘₐₓ and āₘᵢₙ of different types of gear design.

FIG. 5A shows a schematic of a simplified multiple impact system according to some embodiments.

FIG. 5B shows a free body diagram of the simplified multiple impact system with soft foam (k₁ and c₁), sheet (k₂ and c₂), and block (k₃ and c₃) for modeling.

FIG. 6 is a table of material properties of the soft foam, the sheet, and the block utilized in numerical simulation.

FIG. 7A illustrates the experimental validation of numerical simulation with displacement and acceleration profiles of the impactor (m₂) and the sample holder (m₁), where T₂=2 mm. Δtₑ and Δtₛ represent the time intervals between minimum and maximum acceleration for experimental and simulated measurements, respectively.

FIG. 7B illustrates the experimental validation of numerical simulation with displacement and acceleration profiles of the impactor (m₂) and the sample holder (m₁), where T₂=3 mm. Δtₑ and Δtₛ represent the time intervals between minimum and maximum acceleration for experimental and simulated measurements, respectively.

FIG. 8 illustrates initial cavitation in 0.75 w/v % agarose, where the left panel indicates the acceleration profiles without cavitation and the right panel indicates the acceleration profiles with cavitation. The curves labeled as z-axis and y-axis show vertical and horizontal acceleration, respectively. To timely trigger the data acquisition system, the horizontal acceleration (i.e., perpendicular to the impact direction) is used for capturing first cavitation after multiple impacts.

FIG. 9A illustrates preliminary results of the repetitive impact response in agarose 0.75 w/v % gel, where cavitation occurred after 3 impacts with gear type 3. The corresponding high-speed images (i.e., no cavitation (left) and cavitation (right)) are shown. a_{cr}, a_{cl}, t_{cr}, and t_{cl} represent the acceleration and time values for cavitation nucleation and collapse, respectively.

FIG. 9B illustrates preliminary results of the repetitive impact response in agarose 0.75 w/v % gel, where cavitation occurred after 13 impacts with gear type 3. The corresponding high-speed images (i.e., no cavitation (left) and cavitation (right)) are shown. a_{cr}, a_{cl}, t_{cr}, and t_{cl} represent the acceleration and time values for cavitation nucleation and collapse, respectively.

FIG. 9C illustrates preliminary results of the repetitive impact response in agarose 0.75 w/v % gel, where cavitation occurred after 27 impacts with gear type 1. The corresponding high-speed images (i.e., no cavitation (left) and cavitation (right)) are shown. a_{cr}, a_{cl}, t_{cr}, and t_{cl} represent the acceleration and time values for cavitation nucleation and collapse, respectively.

FIG. 9D illustrates preliminary results of the repetitive impact response in agarose 0.75 w/v % gel, where cavitation occurred after 52 impacts with gear type 1. The corresponding high-speed images (i.e., no cavitation (left) and cavitation (right)) are shown. a_{cr}, a_{cl}, t_{cr}, and t_{cl} represent the acceleration and time values for cavitation nucleation and collapse, respectively.

FIG. 10 shows the critical acceleration of agarose 0.75 w/v % gel as a function of the number of impacts applied to the gel until capturing an initial cavitation event. The mean critical acceleration of the agarose gel with a single impact is denoted as the star with a 95% confidence interval. All other data points from the repetitive impacts are denoted with an x marker in the plot.

FIG. 11A illustrates the 3 successive measured acceleration profiles for different gear designs with a silicone rubber sheet thickness of T₂=2 mm.

FIG. 11B illustrates the 3 successive measured acceleration profiles for different gear designs with a silicone rubber sheet thickness of T₂=3 mm.

FIG. 12 illustrates a dynamic mechanical analysis of lower soft foam with different displacements (0.2, 0.6, 1.0, and 2.0 mm). The storage (a) and loss modulus (b), and phase angle (i.e., damping ratio) of lower soft foam are measured via dynamic compression test.

FIG. 13A illustrates a free body diagram of an impactor and a rubber block for numerical estimation of rubber block mechanical properties. FIG. 13B shows the experimental and simulated results of impactor acceleration with the use of fitted ζ₃ and k₃. x′₂ is a displacement of m₂ only affected by the rubber block. The R² value for the use of fitted ζ₃ and k₃ is 0.83.

FIG. 14 illustrates the critical acceleration (a_{cr}, the corresponding acceleration at the onset of cavitation) for water and 0.75 w/v % agarose gel under single impact conditions.

FIG. 15A illustrates the measured acceleration profiles for different gear designs with a silicone rubber sheet thickness of T₂=2 mm. The accelerometer is located on the tube ring.

FIG. 15B illustrates the measured acceleration profiles for different gear designs with a silicone rubber sheet thickness of T₂=3 mm. The accelerometer is located on the tube ring.

FIG. 16 illustrates the maximum acceleration for each impact as a function of the number of impacts with the use of 3 crescent arcs and 3 teeth for each arc.

### DETAILED DESCRIPTION

Detailed aspects and applications of the disclosure are described below in the following drawings and detailed description of the technology. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the disclosure. It will be understood, however, by those skilled in the relevant arts, that embodiments of the technology disclosed herein may be practiced without these specific details. It should be noted that there are many different and alternative configurations, devices and technologies to which the disclosed technologies may be applied. The full scope of the technology disclosed herein is not limited to the examples that are described below.

The singular forms “a,” “an,” and “the” include plural referents unless the context clearly dictates otherwise. Thus, for example, reference to “a step” includes reference to one or more of such steps.

The words “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented but have been omitted for purposes of brevity.

Throughout the description and claims of this specification, the words “comprise” and “contain” and variations of the words, for example “comprising” and “comprises”, mean “including but not limited to”, and are not intended to (and do not) exclude other components.

As required, detailed embodiments of the present disclosure are included herein. It is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the disclosure to be better understood. However, they are given merely by way of guidance and do not imply any limitation.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

More specifically, this disclosure, its aspects and embodiments, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

Understanding of the mechanical properties of biologically relevant soft materials becomes increasingly important for developing a comprehensive knowledge of the underlying injury mechanism and emerging biomedical applications such as tissue regeneration, and shockwave lithotripsy. However, accurately characterizing soft matters, particularly under harsh conditions (i.e., high strain rate and repetitive loadings) at which other rheological techniques are not performed, remains limited due to their complex behaviors associated with their ultra-soft nature and brittle manner from high water content.

The present disclosure relates to a repetitive impact system 100 for testing soft materials. The repetitive impact system 100 comprises a drop tower 102 integrated with a motor system 104 to convert rotational to translational motion. The system 100 can tightly control impact characteristics such as impact amplitude and the number of impacts over time through a change of gear design and impact surface conditions. In some embodiments, this allows the system 100 to continuously deliver a smooth, rapid impact-induced acceleration trajectory to the soft sample. As one of the implications for the integrated system 100, the present disclosure quantifies the critical acceleration (a_{cr}) that corresponds to the onset of the first cavitation for pure water and agarose 0.75 w/v % gel. The a_{cr}s for both materials strongly depends on the size of the sample and interestingly, the agarose sample shows that the der is dependent on impact characteristics: its a_{cr} significantly decreases as an increase of total number of impacts before initial cavitation nucleation. Finally, the present disclosure provides a novel non-optical detection method of initial cavitation nucleation while conducting successive drop events based on cavitation collapse induced structural resonance of the sample holder along non-impact directions.

As noted above, soft materials play a crucial role in the field of biomedical engineering and biomaterial development. However, the use of the instruments for characterizing biomaterials (e.g., hydrogels or tissues) is challenging because of their soft and highly compliant nature. Under an external mechanical insult, biological materials show complex responses that are associated with their dual fluid-like and solid-like nature, which leads to strain rate dependent material properties. On top of that, due to high water contents, the biomaterials are likely to experience fatigue-induced or accumulated damage-induced failure in a brittle manner, mostly after multiple, repetitive loadings. Conventional techniques are incapable of evaluating dynamic properties of the soft samples in high frequencies or high strain rate loading conditions (>10²/s).

According to some embodiments, the drop tower-based repetitive impact system 100 disclosed herein allows for non-invasive characterization of soft, labile materials by applying a rapid, smooth acceleration profile at a relatively broad range of strain rates (1-10⁵/s). This sudden acceleration change can induce a pressure gradient in the soft medium, which leads to cavitation nucleation. The capability to associate physical parameters (i.e., acceleration and its change over time) with the onset of cavitation can be helpful to understand underlying injury mechanisms in the situation of rapid acceleration of the human body or tissue simulant via mechanical input such as collision during contact sports and bullet or shock wounds during military operations. In addition, an important aspect of the presently disclosed system is its ability to offer continuous, repetitive mechanical inputs (i.e., acceleration profiles) on the testing sample with tightly controlled experimental conditions (e.g., impact frequency and amplitude).

The present disclosure is related to a drop tower-based repetitive impact system 100 for characterizing soft biomaterials under varying mechanical loading conditions that a human body frequently encounters. The drop tower-based repetitive impact system 100 may include a motor system 104, a sample holder 106, a testing platform 108, and a triggering algorithm. These features offer the following advantages: 1) precisely controllable impact characteristics (i.e., the number of impacts over time and impact amplitude) by changing the motor gear designs, 2) utilization of various sizes of the testing samples, which are directly relevant to different human organ scales, and 3) an automatic detection of initial cavitation burst synchronized with the corresponding optical and mechanical data sets. An impact-induced acceleration can be systematically tuned by a series of springs and dampers placed between a movable mass and the sample holder.

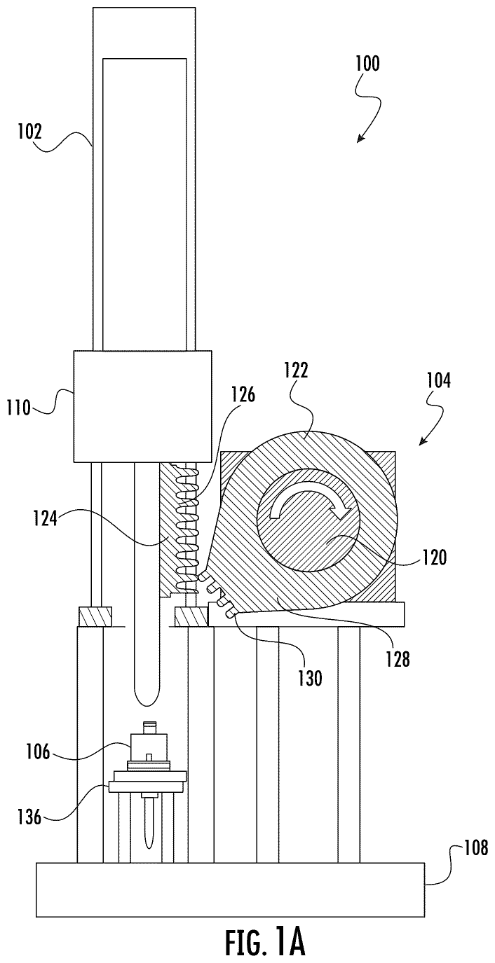

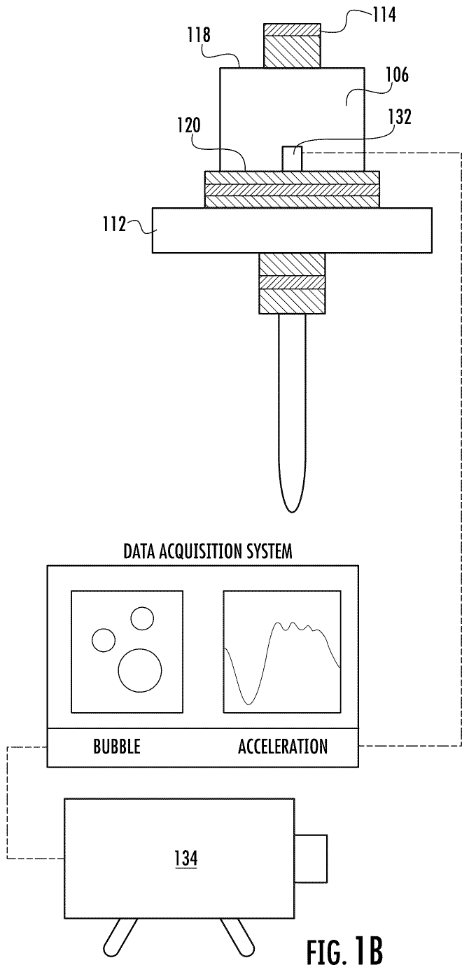

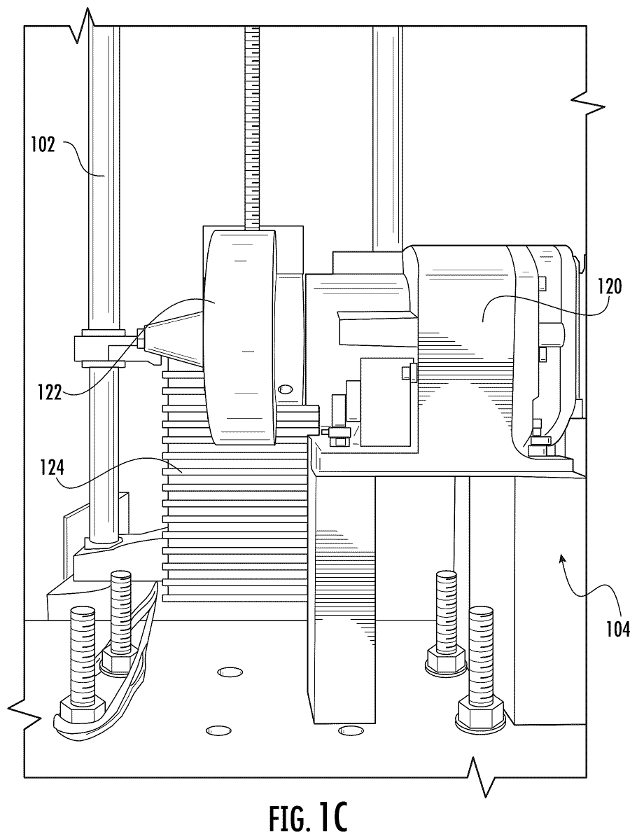

As shown in FIGS. 1A-1C, in some embodiments, the present disclosure relates to a repetitive impact system 100 that comprises a drop tower 102, a sample holder 106, and a motor system 104. The drop tower 102 may have a moveable mass 110 configured to move in a vertical direction with respect to the drop tower 102. The sample holder 106 may be configured to contain a soft material sample and may be positioned in a path of travel of the moveable mass 110 with respect to the drop tower 102. In some embodiments, the sample holder 106 has a foam material 112 and a rubber material 114 layered on one or both of a bottom surface 116 and a top surface 118 of the sample holder 106. This helps to control the impact characteristics of the moveable mass 110 on the sample holder 106. In some embodiments, the rubber material 114 comprises a silicone rubber sheet.

The motor system 104 may be configured to repeatedly lift the moveable mass 110 up and drop the moveable mass 110 on the sample holder 106. The sample holder 106 may be aligned with the moveable mass 110. For example, a center of mass of the sample holder 106 may be aligned with a center of mass of the moveable mass 110. As another example, a geometric center of the sample holder 106 may be aligned with a geometric center of the moveable mass 110. By aligning the sample holder 106 with the moveable mass 110, the effect of the impact on the soft sample can be isolated from other forces and moments that would act on the soft sample if the sample holder 106 and the moveable mass 110 were not aligned.

In some embodiments, the motor system 104 comprises a motor 120, a pinion gear 122, and a rack 124. The motor 120 may be configured to rotate at a constant rate. The rack 124 may be attached to and configured to move with the moveable mass 110. In some embodiments, the rack 124 has a plurality of teeth 126. The pinion gear 122 may be attached to the motor and may have at least one crescent 128 with at least one tooth 130. The crescent 128 is the portion of the pinion gear 122 that extends beyond the circular shape of the center of the gear 122, and thus allows the pinion gear 122 to periodically reach further away from the center of the gear 122. In some embodiments, the pinion gear 122 is a partial gear. When the motor 120 rotates, the pinion gear may be configured to rotate with the motor 120 such that the at least one crescent 128 circles about the motor 120. In some embodiments, the pinion gear 122 is positioned to allow the at least one tooth 130 of the at least one crescent 128 to interface with the plurality of teeth 126 of the rack 124 when the at least one crescent 128 is closest to the rack 124.

The pinion gear 122 may be configured to fail before other components of the repetitive impact system 100. By selecting and designing the pinion gear 122 to fail first, the other components in contact with the pinion gear 122, such as the motor and the rack 124, avoid undue wear. This is beneficial because the pinion gear 122 can be easily and cheaply produced, and can be easily switched out. In fact, in some scenarios, the user may want to switch out the pinion gear 122 frequently to test different drop heights. Thus, the pinion gear 122 may be treated as consumable to help preserve and lengthen the functional life of the other components involved.

When the at least one tooth 130 of the at least one crescent 128 interfaces with the plurality of teeth 126 of the rack 124, the pinion gear 122 is configured to lift the rack 124 and the moveable mass 110 up to a desired height and drop the rack 124 and the moveable mass 110 to impact the sample holder 106. In some embodiments, the height of the drop is controlled by the number of teeth of the at least one tooth 130. For example, when the pinion gear 122 has just one tooth 130, the pinion gear 122 will be in contact with the rack 124 for less time and lift rack 124 to a lower height than if the pinion gear 122 has four teeth 130. As the motor 120 rotates, lifting and dropping the moveable mass 110 may occur repeatedly.

The repetitive impact system 100 may also comprise an accelerometer 132 on, adjacent to, and/or in contact with the sample holder 106. The accelerometer 132 is configured to detect an acceleration value of the sample holder 106. In some embodiments, the accelerometer 132 is configured to detect an acceleration value of the sample holder 106 in a horizontal direction perpendicular to the vertical direction (aligned with the path of travel of the moveable mass 110). The repetitive impact system 100 may comprise a camera 134 configured to take an image of the sample holder 106 in response to detection of the acceleration value of the sample holder 106 rising above a threshold acceleration value.

The present disclosure also relates to a method for detection of initial cavitation nucleation while applying repeated impacts. This method may comprise any components described above with respect to the repetitive impact system 100, and may include any of the steps described as well. In some embodiments, the method comprises providing a sample holder 106 configured to contain a soft material sample. An accelerometer 132 may be positioned in contact with the sample holder 106. The sample holder 106 may be impacted repeatedly with a moveable mass 110 moving in a first direction. A threshold acceleration value for the accelerometer may be selected, where the threshold acceleration value corresponds with an acceleration in a second direction that is perpendicular to the first direction. The accelerometer may be used to detect initial cavitation nucleation within the soft material sample by detecting an acceleration value higher than the threshold acceleration value.

In some embodiments, the method further comprises taking an image of the sample holder 106 with a camera 134 in response to detecting the acceleration with the value higher than the threshold acceleration value. The method may also comprise repeatedly lifting the moveable mass 110 with a motor 120 and dropping the moveable mass 110 on the sample holder 106. In some embodiments, the method comprises providing a pinion gear 122 attached to the motor 120 to lift the moveable mass 110. The method may also comprise configuring the pinion gear 122 to fail before other components involved in the repeated impacts.

In some embodiments, the repetitive impact system 100 may comprise a drop weight tower 102, high speed camera 134, sample holder 106, accelerometers 132, data acquisition system 131, and motor system 104 (see FIG. 1). Soft gel samples may be stored inside clear long plastic tubes (16×150 mm) for simulating mechanical responses of soft gels. Individual tubes may be sealed with a cap and glued into a tube ring connected to the tube holder. The tube holder is linked with the sample holder 106, which may have two horizontal plates connected by four vertical columns. In some embodiments, all the parts except the tube are connected to each other via M3 bolts and nuts, and silicone rubber sheets are placed in between each part to avoid any unwanted solid-solid collision. As noted above, the soft resilient foam 112 and silicone rubber sheet 114 may be attached to the bottom and top of the sample holder 106 to control the impact characteristics and the induced acceleration during the impact. In some embodiments, this system 100 is continuously capable of applying rapid and smooth acceleration trajectories to a soft sample without any shock waves.

The assembled sample holder 106 is placed on the impact anvil 136 (see FIG. 1A). Weight and height of the impactor as well as the number of impacts over time are three main parameters that determine the total amount of kinetic energy during a specific time. The motor system 104 is configured to provide continuous and repetitive impact events. The motor system 104 converts rotational motion into translational motion by using a rack 124 and pinon gear 122 (see FIG. 1A) attached to the impactor or moveable mass 110 and motor 120, respectively. With the rack 124 and pinion 122, the rotation of the pinion 122 causes linear motion of the rack 124 such that the linear travel distance of the rack 124 depends on the number of continuous gear teeth with a fixed pinion pitch diameter, which is directly related to the drop height (i.e., a vertical drop height of a movable impactor with respect to the sample holder) as well as impact-induced acceleration magnitude. With a constant motor rotational speed, the number of continuous gear teeth arcs affects an impact frequency (i.e., total number of impacts over time). In sum, the number of crescents (i.e., continuous gear teeth arcs in one arc) and number of gear teeth along each arc are used to control the impact frequency and magnitude, respectively.

In some embodiments, a data acquisition system 131 with a high-speed camera 134 with 2× magnification lens (Tokina at-X PRO M 100-MM F2.8 D Macro lens and Kenko TELEPLUS HD DGX 2×) and 50 kfps frame rate may be triggered by the onset of impact or initial cavitation nucleation and synchronized with the corresponding acceleration profile at 10⁻⁶ s sampling rate. Resultant data sets may be obtained via NI PXIe-8135 embedded controller and an NI PXI-6115 multifunction I/O module with SignalExpress 2014 data acquisition software (National Instruments Corporation., Austin, TX). More details about a presentative acceleration profile during repetitive drop experiment and initial cavitation detection algorithm are provided below.

In some embodiments, the motor system 104 utilizes a rack and pinion system where the pinion 122 is only a partial gear. This partial or crescent gear allows the rack 124 to engage and then release continuously in a vertical direction, stemming from the constant rotational motion of the motor 120. The motor 120 used in this system may be a Nord AC Gearmotor that operates at a constant 38 revolutions per minute with a maximum torque of 186 N-m. This motor is controlled with an on/off switch through the power supply.

In some embodiments, the motor 120 is connected to the drop tower setup using a custom-built platform that screws into the threaded grid patterned base plate of drop tower. Eight high strength steel threaded rods cut to a length of 75 cm may be used to hold up an aluminum platform (see FIG. 1A). The eight rods provide adequate strength to secure the motor 120 in position in all directions, even when under load. The aluminum plate allows the motor to mount to the threaded rods and thus align the motor 122 to the drop tower plunger apparatus. The aluminum plate may be connected to the threaded rods with nuts, which allows the platform to be raised or lowered to properly align the rack 124 and pinion gears 122. The motor 120 may be mounted to the aluminum platform with 8-inch-long screws and 6-inch-long aluminum spacers. This leaves ample space below the motor 120 for the threaded rod adjustment length.

In some embodiments, the rack 124 and pinion gear 122 mechanisms are constructed of 3D printed polymer. This polymer may be eSUN PLA PRO 3D Printer Filament. The pinion gear 122 may be press-fitted on to a Metal Gear (McMaster 6867K4) which keys on to the motor shaft. This metal gear provides ample surface area to transfer the motor forces to the polymer gears without causing areas of high stress. In some embodiments, the 3D printed rack 124 press fits onto the drop tower plunger mass and is secured with a screw ring.

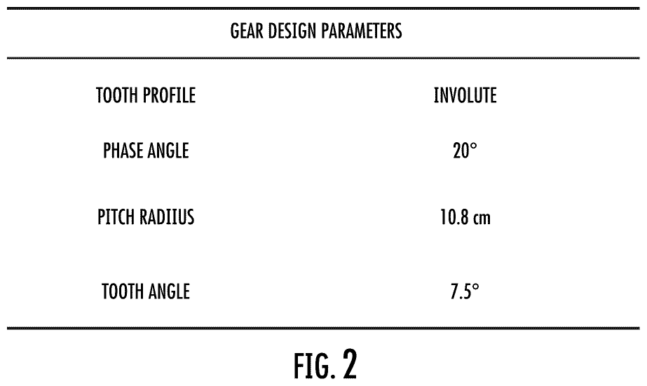

The design of the gears 122 may be based on an involute tooth profile. The gear design parameters given in FIG. 2 detail the shape of the gears utilized in some embodiments. The 3D printing of the gears allows for rapid change of the tooth profiles. The design of the partially crescent pinion 122 controls the impactor drop frequency and drop height (i.e., closely related to the impact magnitude). With the given gear design parameters (see FIG. 2), each tooth on the pinion gear 122 accounts for 7.5° out of an entire gear 360° profile. An arc of gear teeth is created by cutting the pinion gear such that only a select number of gear teeth remain.

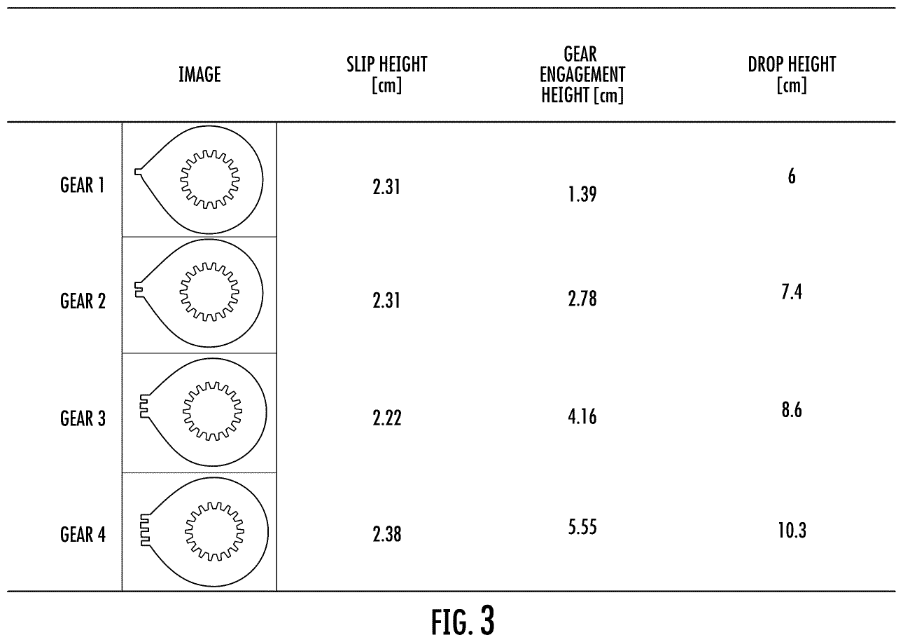

There are two slip conditions that occur with a crescent pinion gear design, the pre-slip condition and the post-slip condition. When the teeth first make contact, a slipping motion between the two teeth occurs until the gear teeth are fully engaged or mated. When fully engaged, no slipping occurs, and the gears operate as expected. After the final tooth in a crescent gear gets pulled out from the fully engaged position, another slipping condition occurs between the pinion teeth and the rack teeth. These two slipping conditions result in additional vertical drop height no matter the arc size of the crescent gear. In other words, the slipping between the two gears between no-contact to fully engaged contact has a consistent height which is around 2.3 cm (see FIG. 3) for the given gear profile. The drop height for a given gear profile is two times the slip height plus the height from the arc length of the pinion gear crescent. This controllable height from the gear arc is called the gear engagement height (see FIG. 3). In some embodiments, the center of the motor axis to the gear rack is approximately 10.5 cm which, for one tooth with an arc of 7.5° results in an arc length of 1.37 cm in accordance with FIG. 3. Controlling the drop height magnitude is thus conducted through a change of the number of gear teeth along an arc in the crescent gear 122.

The frequency of the drops is controlled by putting additional crescent of continuous gear teeth arc on the pinion gear 122. However, a frequency ceiling arises which limits the number of crescents on one gear. This ceiling is due to the settling time of the drop tower system. The plunger or moveable mass 110 must have adequate time to settle before the next engagement of the pinion gear 122. Otherwise, misalignment will occur and damage to the system can result.

Due to the slipping (i.e., friction) of the gear teeth, the gear and rack experience significant wear over time. Thus, the 3D printed gears 122 may be treated as consumable, needing to be replaced after extended use. In some embodiments, the motor system 104 is constructed of high strength steel and the gears 122 are constructed of relatively weak polymer. In such embodiments, if an issue arises, such as misalignment of the gear teeth at contact, then the polymer gears will break before the rest of the motor system 104. This prevents costly damage and provides rapid development of new testing procedures.

### Dynamic Mechanical Analysis of Soft Resilient Foam

Dynamic mechanical tests are conducted by DMA 3200, New Castle, DE. The cylindrical soft resilient foams with dimensions of 1 cm radius with 1.4 cm thickness are examined on the 1.25 cm radius compression plate having maximum 500 N capacity. Tests are performed to study the strain- and strain rate-dependent mechanical properties (i.e., storage and loss modulus, and damping ratio) of the soft resilient foam with different displacements (i.e., 0.2, 0.6, 1.0, 2.0 mm) using frequency weep mode ranging from 0.1 to 100 Hz at a constant room temperature. Three specimens of each condition are tested for dynamic mechanical analysis.

### Soft Gel Preparation

The equipment used to prepare the samples may include an electronic balance, hot plate and stirrer, 1000 ml glass beaker, electronic pipette, pure ponta weigh boats, ultra-pure DI water, and/or agarose (Invitrogen, REF 16500-100, LOT0001189939).

The sample preparation process may begin by adding 300 ml of DI water into the 1000 ml beaker and setting it on the hot plate at 350° C. Next, a pure Ponta weight boat may be zeroed on the electronic balance. The necessary sample in powdered form may be poured onto the weigh boat and measured to the desired weight. The weight is found from the desired concentration and the known water volume, most commonly, 300 ml. So, for agarose 0.75 w/v % gel, dissolved into 300 ml, 2.25 grams of powdered sample are needed. When the water on the hot plate is just starting to boil, the stirrer is engaged, and the powder sample is slowly and continuously poured in. Ample time is given to let the powder completely dissolve into the water. Water is also continuously added in small quantities to maintain the 300 ml. During the dissolving process, 15 clear sample tubes may be rinsed three times each in the sink using de-ionized water. After complete dissolving of the sample, the hot plate temperature may be reduced to 35° C. and set to cool with the stirrer still running. After cooling, the pipette may be used to fill the sample tubes to their desired fill height. The samples may then be cooled at room temperature.

### Experimental Characterization

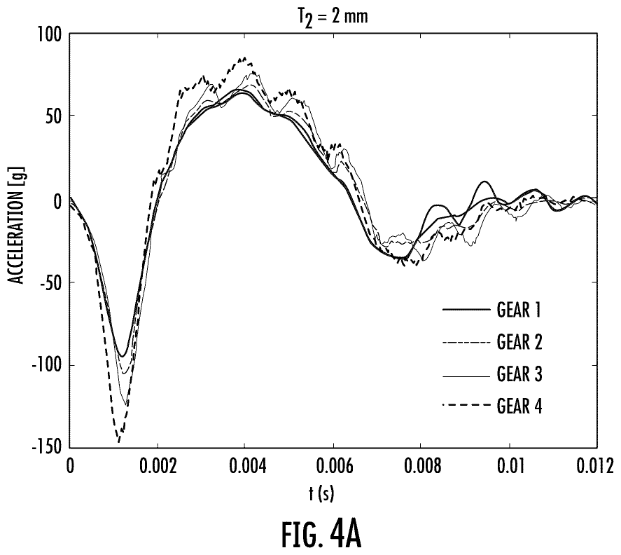

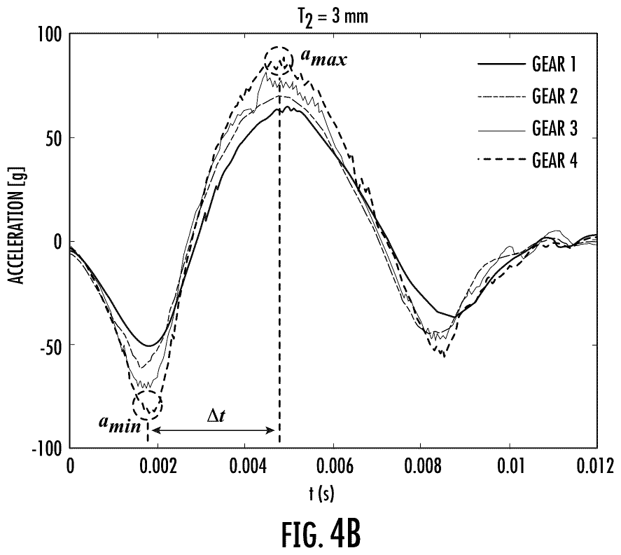

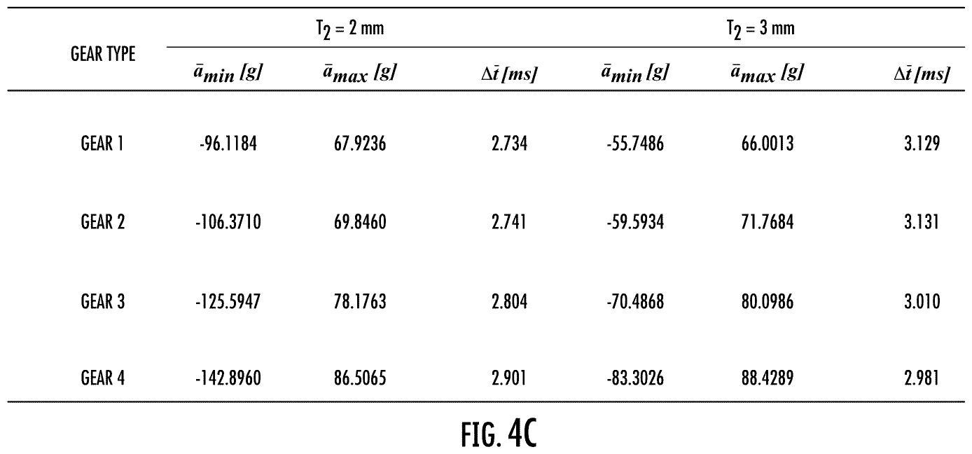

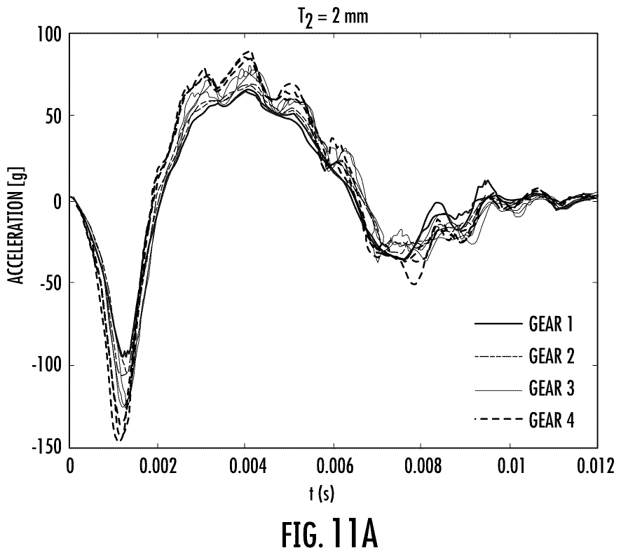

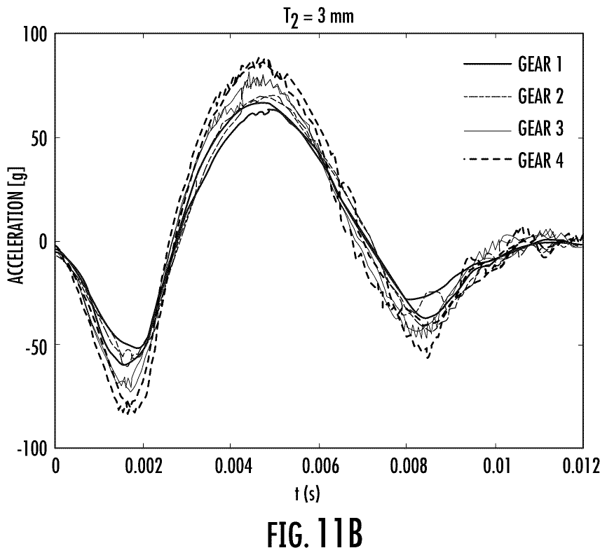

Experimental characterization of the repetitive impact tester involved the clear long plastic tube with agarose 0.75 w/v %. To control the characteristics of impacts, the number of gear teeth along a crescent (hereinafter cited as teeth number) and thickness of the silicone rubber sheet (i.e., T₂) were changed, with the results shown in FIGS. 4A and 4B. The system's capability to withstand repeated impacts without any significant change in the impact response of the sample holder 106 was confirmed by repeating three successive drops from each condition (see FIGS. 11A and 11B). Individual measured mechanical quantities (i.e., minimum and maximum acceleration as well as time intervals between them) are averaged (i.e., denoted as āₘᵢₙ, āₘₐₓ, and Δt̅, respectively) and summarized in FIG. 4C. As shown in FIGS. 4A and 4B, vertical acceleration (i.e., acceleration along the impact direction) responses of the sample holder from the same gear types are relatively consistent for all the cases. Since a greater number of teeth result in a higher drop height, as shown in FIG. 3, the amplitude of the first trough gradually increases as the number of teeth increases. In addition, the āₘᵢₙ of each gear type is linearly proportional to drop height (fit equation: āₘᵢₙ [g]=−14.46·h [cm] (i.e., drop height) for T₂=2 mm with R²=0.9 and āₘᵢₙ [g]=−8.27·h [cm] for T₂=3 mm with R²=0.9). The use of larger T₂ reduces the induced āₘᵢₙ amplitude, while increasing the response time interval (i.e., Δt̅) between the first and second trough of the acceleration profile. Interestingly, the āₘₐₓ values do not show any noticeable change between T₂=2 and 3 mm as shown in FIG. 4C. It is worth noting that the acceleration of the sample holder goes back to equilibrium state (˜0 g acceleration) within 0.012 ms for all cases. This confirms that the prior impact response of the sample holder would not affect the next drop event while applying repetitive impacts.

### Theoretical Modeling

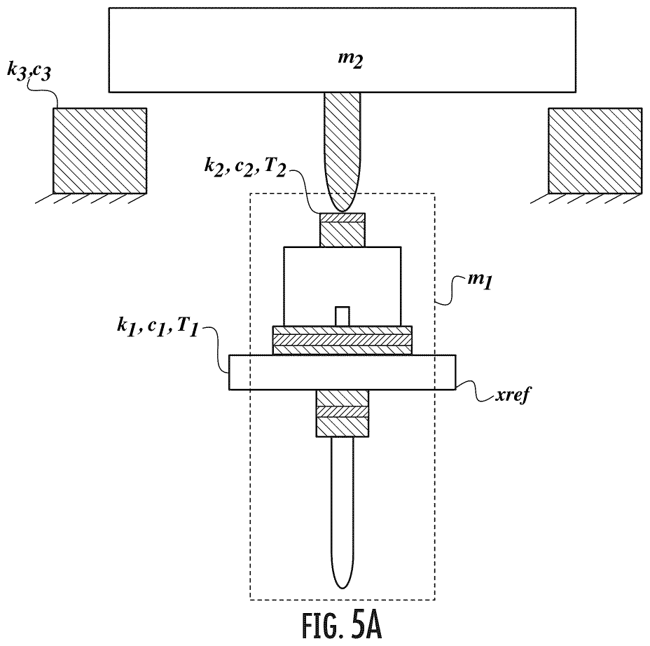

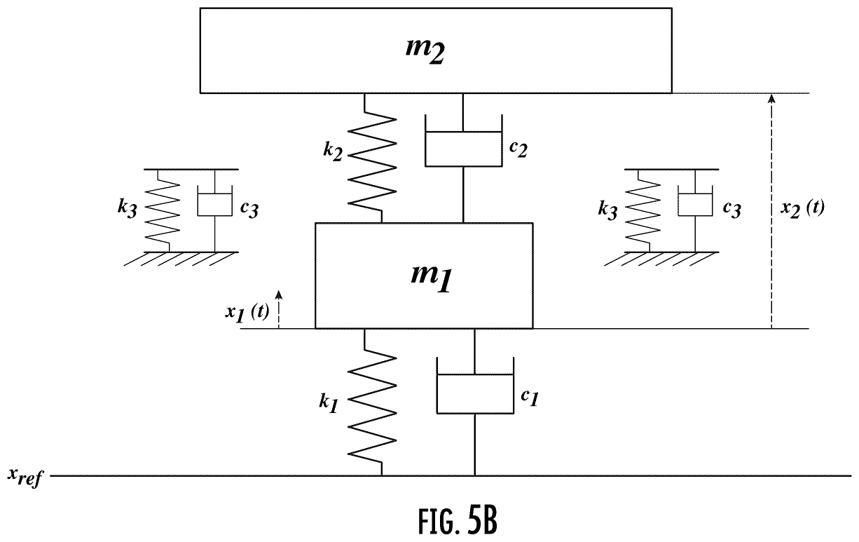

In order to consistently apply the well-controlled acceleration profile to soft material samples, a thorough understanding of the impact responses between the sample holder and impactor is necessary. In this regard, a systematic theoretical approach was performed to characterize the transient dynamic response of the system, as shown in FIG. 1A and FIG. 5A. The main focus is placed on providing high-strain rate conditions, characterized by a smooth, consistent acceleration to the sample holder.

FIG. 5B represents a two-degree-of-freedom schematic model of the system. Two movable masses denote the sample holder (m₁) and impactor (m₂), respectively. Three sets of a linear spring (kᵢ) and damper (cᵢ) represent the soft resilient foam and silicone rubber sheet with thickness (T₁ and T₂, respectively) as well as the rubber block where i=1, 2, and 3. When m₂ is dropped at drop height, h, it freely falls until an engagement happens between the silicone rubber sheet and m₂. The silicone rubber sheet and the soft resilient foam are attached to m₁ which is in a stationary state on the rigid anvil (x_{ref}). Note that when the impactor contacts the rubber block, there is an offset distance (dₑ=1 mm) between m₂ and m₁ without the silicone rubber sheet. However, with a relatively thick silicone rubber sheet (T₂>1 mm), the m₂ first contacts with the silicone rubber sheet and then, when a travel distance of the m₂ after the first engagement with the rubber sheet is more than T₂−dₑ, another contact occurs between m₂ and the fixed rubber block. This avoids excessive contact depth of the silicone rubber sheet, due to a large m₂ mass.

For simplicity, it is assumed that m₁ and m₂ move only along a vertical impact direction. This assumption is fairly reasonable by considering that (1) the impactor motion is guided by metal guide rails (see FIG. 1) and (2) motion of the sample holder 106 is constrained by the center hole of the anvil 136, which helps the impactor 110 and sample holder 106 align each other along the vertical axis. Again, the focus is to characterize the transient, dynamic, but repetitive response of the system 100 such that the above constraints would provide better system stability and repeatability during the long-time operation. The initial condition of the theoretical analysis is when m₁ and m₂ first contact each other via the silicone rubber sheet (see FIG. 5). The corresponding mathematical notation is x₂(t)−x₁(t)=T₂ at t (i. e., time)=0 in which x₂(t) and x₁(t) describe the vertical location of the impactor (m₂) and the sample holder (m₁) in time (i.e., displacement) from the initial position of the sample holder (x₁(0)), respectively

The governing equation of the two-degree-of-freedom system in FIG. 5B can be described as follows:

$$For {m}_{1} : {m}_{1} \ddot{{x}_{1}} + {c}_{1} \dot{{x}_{1}} + {c}_{2} ( \dot{{x}_{1}} - \dot{{x}_{2}} ) + {k}_{1} {x}_{1} + {k}_{2} ( {x}_{1} - {x}_{2} + {T}_{2} ) = - {m}_{1} g \qquad ( 1 )$$

$$For {m}_{2} : \{ \begin{matrix}{m}_{2} \ddot{{x}_{2}} + {c}_{2} ( \dot{{x}_{2}} - \dot{{x}_{1}} ) + {k}_{2} ( {x}_{2} - & if {x}_{2} ( t ) \geq {d}_{e} \\ {x}_{1} - {T}_{2} ) = - {m}_{2} g , & \\ {m}_{2} \ddot{{x}_{2}} + {c}_{2} ( \dot{{x}_{2}} - \dot{{x}_{1}} ) + {k}_{2} ( {x}_{2} - {x}_{1} - {T}_{2} ) + & if {x}_{2} ( t ) < {d}_{e} \\ {c}_{3} {\dot{x}}_{2} + {k}_{3} ( {x}_{2} - {d}_{e} ) = - {m}_{2} g , , & \end{matrix} \qquad ( 2 )$$

where dₑ(=1 mm) is the offset distance between the impactor and rubber block when m₁-m₂ initially contact through the silicone rubber sheet and g is the gravitational acceleration. Note that depending on x₂(t), the spring-damper of the rubber block is either active (x₂(t)<dₑ) or not (x₂(t)≥dₑ). On top of that, the dynamics of the system in Eq. (1) and (2) can be further decomposed into four additional phases which are triggered by the onset of specific events: contact and separation between m₁ and anvil (x_{ref}) or between the m₁ and m₂. For this step, the detailed phase equations are listed as follows:
(phase 1) m₁ and x_{ref} as well as m₁ and m₂(0≥x₁(t)>−T₁ and T₂≥x₂(t)−x₁(t)>0) are in contact with the soft resilient foam and silicone rubber sheet (i.e., k₁−c₁ and k₂−c₂ are both active);
(phase 2) m₁ and m₂ are in contact (T₂≥x₂(t)−x₁(t)>0) are in contact with the silicone rubber sheet, but separation happens between m₁ and the soft resilient foam (x₁(t)>0) (i.e., k₂−c₂ is only active);
(phase 3) m₁ and x_{ref} is in contact with the soft resilient foam (0≥x₁(t)>−T₁), while separation happens between m₁ and m₂(x₂(t)−x₁(t)>T₂) (i.e., k₁−c₁ is only active);
(phase 4) m₁ and x_{ref} as well as m₁ and m₂(x₁(t)>0 and x₂(t)−x₁(t)>T₂) are separated each other (i.e., k₁−c₁ and k₂−c₂ are both inactive);
   The above governing equation (Eq. (1) and (2)) will be properly adjustable depending on the specific phase of the system.

To simplify the analysis of the system dynamic behavior, y₁(t)=x₁(t), y₂(t)=x₂(t), y₃(t)=\dot{x}₁(t), and y₄(t)=\dot{x}₂(t) such that the state vector is Y=(y₁ y₂ y₃ y₄) which represents the complete internal state of the dynamic system at a specific time. After the first-time derivative of the state vector

$$( i . e . , \frac{dY}{dt} ) ,$$

the corresponding

$$\frac{dY}{dt}$$

of Eq. (1) and (2) for each phase will be represented as follows:

$$\begin{matrix}( phase 1 ) & \\ \frac{{dY}_{1}}{dt} = \{ \begin{matrix}{y}_{3} ( t ) \\ {y}_{4} ( t ) \\ - ( {ω}_{1}^{2} + {ω}_{2}^{2} M ) \cdot {y}_{1} ( t ) + {ω}_{2}^{2} M \cdot {y}_{2} ( t ) - \\ ( 2 {ω}_{1} {ζ}_{1} + 2 {ω}_{2} {ζ}_{2} M ) \cdot {y}_{3} ( t ) + 2 {ω}_{2} {ζ}_{2} M \cdot {y}_{4} ( t ) + α - g \\ 2 {ω}_{2} {ζ}_{2} ( {y}_{3} ( t ) - {y}_{4} ( t ) ) + {ω}_{2}^{2} ( {y}_{1} ( t ) - {y}_{2} ( t ) ) + β - g\end{matrix} & ( 3 )\end{matrix}$$

$$\begin{matrix}( phase 2 ) & \\ \frac{{dY}_{2}}{dt} = \{ \begin{matrix}{y}_{3} ( t ) \\ {y}_{4} ( t ) \\ - 2 {ω}_{2} {ζ}_{2} M \cdot ( {y}_{3} ( t ) - {y}_{4} ( t ) - {ω}_{2}^{2} M \cdot ( {y}_{1} ( t ) - {y}_{2} ( t ) ) + α - g \\ 2 {ω}_{2} {ζ}_{2} ( {y}_{3} ( t ) - {y}_{4} ( t ) ) + {ω}_{2}^{2} ( {y}_{1} ( t ) - {y}_{2} ( t ) ) + β - g\end{matrix} & ( 4 )\end{matrix}$$

$$\begin{matrix}( phase 3 ) & \\ \frac{{dY}_{3}}{dt} = \{ \begin{matrix}{y}_{3} ( t ) \\ {y}_{4} ( t ) \\ - {ω}_{1}^{2} \cdot {y}_{1} ( t ) - 2 {ω}_{1} {ζ}_{1} {y}_{3} ( t ) + α - g \\ β - g\end{matrix} & ( 5 )\end{matrix}$$

$$\begin{matrix}( phase 4 ) & \\ \frac{{dY}_{4}}{dt} = \{ \begin{matrix}{y}_{3} ( t ) \\ {y}_{4} ( t ) \\ - g \\ - g\end{matrix} & ( 6 )\end{matrix}$$

where

$$α = - 2 {ωζ}_{2} M \cdot {T}_{2} , \\ β = \{ \begin{matrix}- 2 {ω}_{3} {ζ}_{3} \cdot {y}_{4} ( t ) - {ω}_{3}^{2} \cdot ( {y}_{2} ( t ) - {d}_{e} ) + 2 {ωζ}_{2} M \cdot {T}_{2} , & {y}_{2} ( t ) \leq {d}_{e} \\ 2 {ωζ}_{2} M \cdot {T}_{2} , & {y}_{2} ( t ) > d\end{matrix} , \\ {ω}_{1} = \sqrt{\frac{{k}_{1}}{{m}_{1}}} , {ω}_{2} = \sqrt{\frac{{k}_{2}}{{m}_{2}}} , {ω}_{3} = \sqrt{\frac{{k}_{3}}{{m}_{2}}} , \\ {ζ}_{1} = \frac{{c}_{1}}{2 {m}_{1} {ω}_{1}} , {ζ}_{2} = \frac{{c}_{2}}{2 {m}_{2} {ω}_{2}} , {ζ}_{3} = \frac{{c}_{3}}{2 {m}_{2} {ω}_{3}} , and M = \frac{{m}_{2}}{{m}_{1}} .$$

While running the dynamic system, hard impacts can occur between m₁ and x_{ref} or m₂ and m₁ when y₁(t)=−T₁ or y₂(t)=y₁(t), respectively. The hard impacts are assumed as inelastic collisions with a coefficient of restitution e (=0.8) based on linear momentum conservation. The state vector immediately after the above hard impacts can be written as follows:

$${m}_{1} and {x}_{ref} : {M}_{{m}_{1}} ( Y ) = \{ \begin{matrix}{y}_{1} ( t ) \\ {y}_{2} ( t ) \\ - {ey}_{3} ( t ) \\ {y}_{4} ( t )\end{matrix} \qquad ( 7 )$$

$${m}_{2} and {m}_{1} : {M}_{{m}_{1} - {m}_{2}} ( Y ) = \{ \begin{matrix}{y}_{1} ( t ) \\ {y}_{2} ( t ) \\ ( eM ( {y}_{4} ( t ) - {y}_{3} ( t ) ) + {y}_{3} ( t ) + {My}_{4} ( t ) ) / ( 1 + M ) \\ ( e ( {y}_{3} ( t ) - {y}_{4} ( t ) ) + {y}_{3} ( t ) + {My}_{4} ( t ) ) / ( 1 + M )\end{matrix}$$

During the system operation, its dynamic responses are composed of different smooth profiles for individual phases such that a jump condition is required to link respective events (i.e., contact, separation, or hard impact event). The contact, separation or hard impact event brings about the use of a different state vector described in Eqs. (3)-(7) and for numerically solving the dynamic system, 6 event surfaces are utilized as follows:
Event 1: Cₘ_{₁}=y₁(t) when y₃ (t)<0 for a contact between m₁ and x_{ref}.
Event 2: Cₘ_{₁}₋ₘ_{₂}=y₂(t)−y₁(t)−T₂ when y₄ (t)−y₃ (t)<0 for a contact between m₁ and m₂.
Event 3: Sₘ_{₁}=y₁(t) when y₃ (t)>0 for a separation between m₁ and x_{ref}.
Event 4: Sₘ_{₁}₋ₘ_{₂}=y₂(t)−y₁(t)−T₂ when y₄ (t)−y₃ (t)>0 for a separation between m₁ and m₂.
Event 5: Iₘ_{₁}=y₁(t)+T₁ when y₃ (t)<0 for an impact between m₁ and x_{ref}.
Event 6: Iₘ_{₁}₋ₘ_{₂}=y₂(t)−y₁(t) when y₄ (t)−y₃ (t)<0 for an impact between m₁ and m₂.

The event surfaces allow for monitoring various events as well as their transitions in time, while numerically simulating the dynamic system. In addition, through the connectivity map between the individual segments of the dynamic trajectories, the complicated correlation between the state vector fields and corresponding event surfaces are organized.

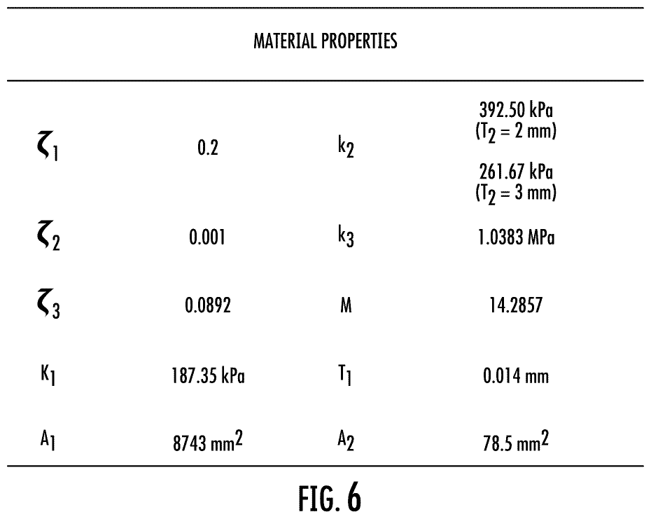

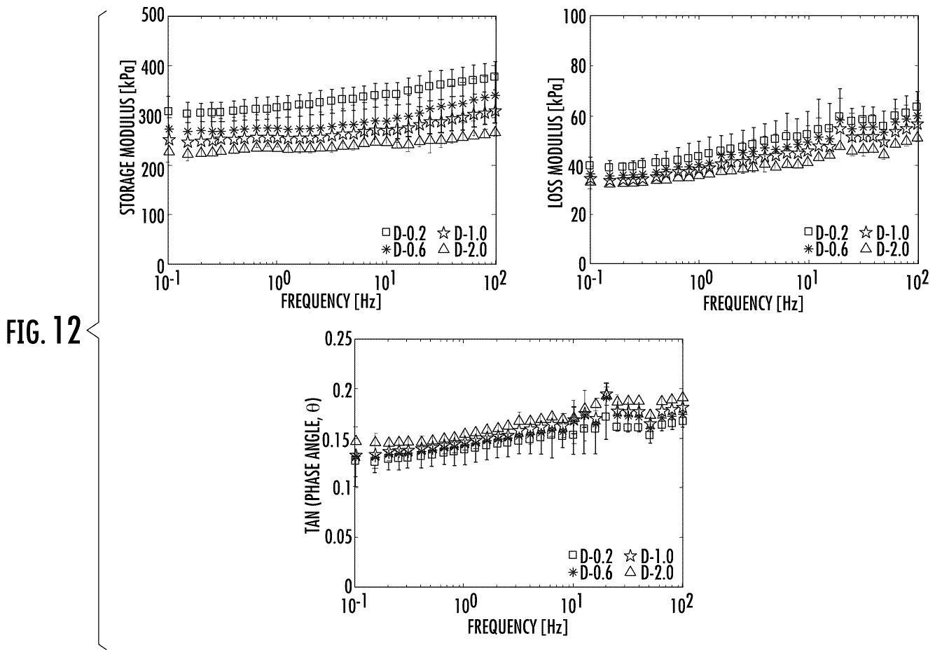

The initial conditions of the numerical simulations are y₁(0)=y₂(0)=y₃ (0)=0, while the velocity of the impactor (y₄(0)) corresponds to −\sqrt{2 gh} by assuming energy conservation during its free fall from the drop height (h) induced by different gear types (see FIG. 3). In this regard, the initial conditions satisfy the phase 1 equation criterion such that the governing equation initially starts with Eq. (3). All other material properties used in the simulation are summarized in FIG. 6. The spring constant of soft resilient foam and silicone rubber sheet are estimated using kᵢ=EᵢAᵢ/Tᵢ in which Eᵢ, Aᵢ, and Tᵢ are elastic modulus, cross-sectional area thickness of the soft resilient foam (i=1) and silicone rubber sheet (i=2). The elastic modulus and damping coefficient of silicone rubber sheet (E₂ and ζ₂, respectively) is referred from previously noted values, while that of soft resilient foam (E₁ and ζ₁, respectively) is measured using the dynamic mechanical analysis (see FIG. 12). On top of that, the mechanical properties of the rubber block (i.e., k₃ and

$${ζ}_{3} = \frac{{c}_{3}}{2 {m}_{2} {ω}_{3}} )$$

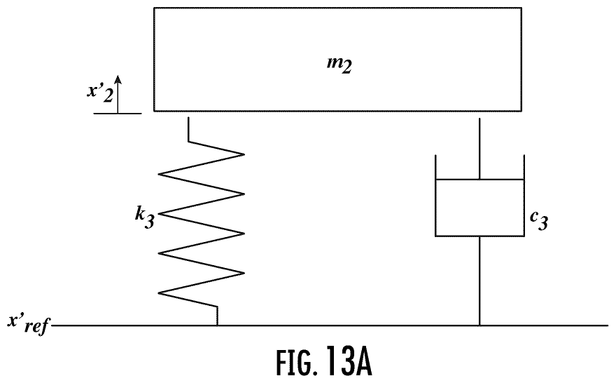

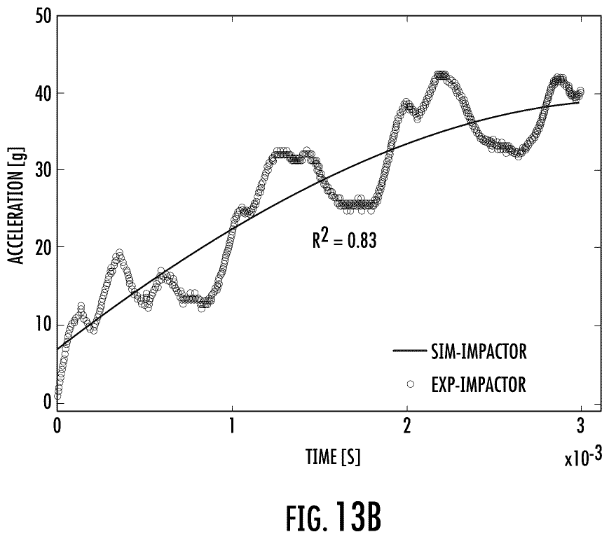

are numerically fitted into

$${m}_{2} {\ddot{{x}^{′}}}_{2} + {c}_{3} ( {\dot{{x}^{′}}}_{2} ) + {{k}_{3} ( {x}^{′} )}_{2} = - {m}_{2} g$$

where x′₂ is a displacement of m₂ only affected by the rubber block by using lsqcurvefit function in MATLAB based on simple mass-spring-damper system (see FIGS. 13A and 13B). Again, a contact between the impactor and the rubber block can always occur after the contact between the impactor and the silicone rubber sheet since the relatively thicker silicone rubber sheet is used (T₂=2 or 3 mm) which is greater than dₑ.

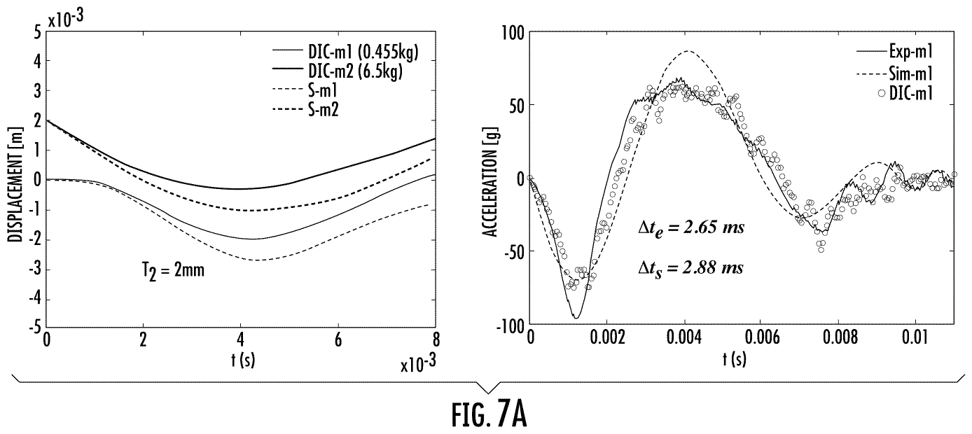

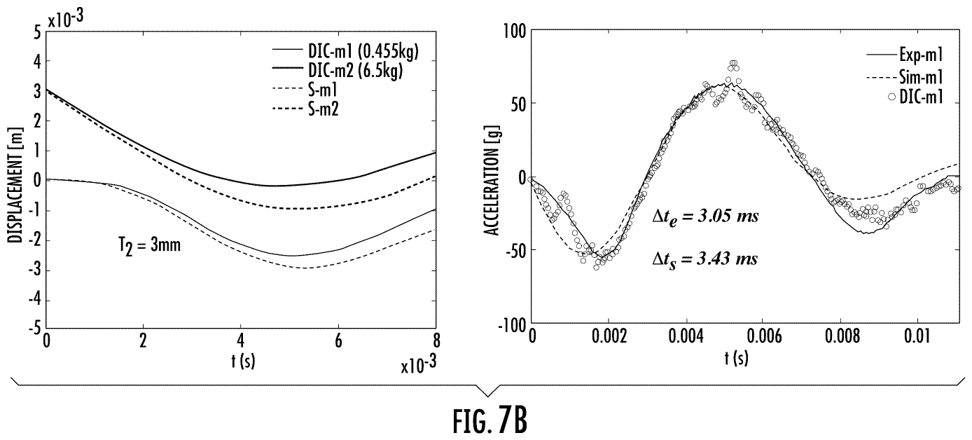

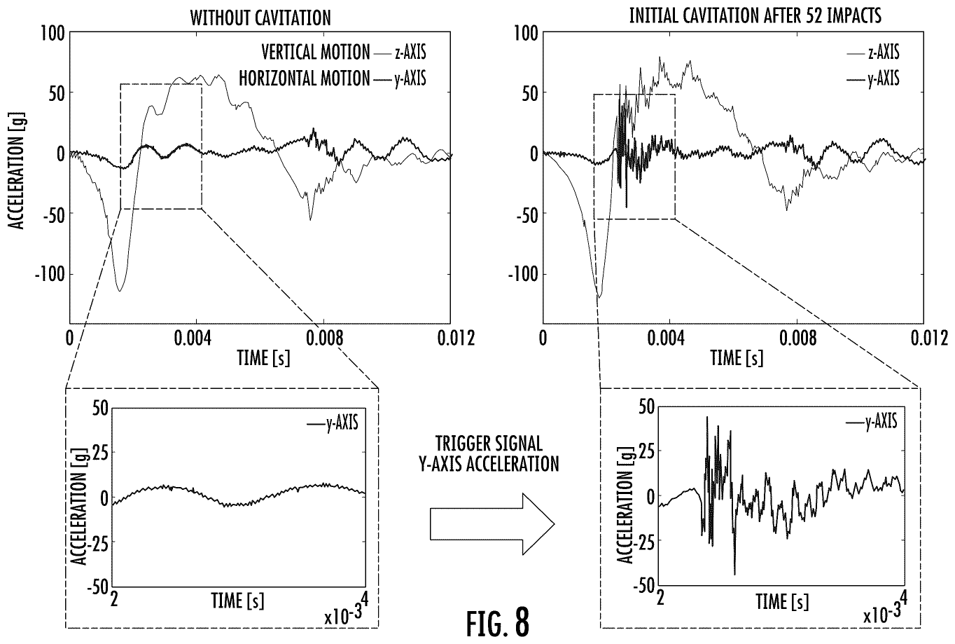

To find the appropriate conditions for using the repetitive impact system 100 to test soft samples, 2 representative cases are explored with the consideration of the realistic mechanical properties (listed in FIG. 6) as well as drop height (h=60 mm induced by Gear type 1) by only changing thickness of the silicone rubber sheet (T₂). First of all, the left plots of FIGS. 7A and 7B show the corresponding experimental measurements (solid line) and numerical prediction (dotted line) of displacement trajectory for the sample holder (m₁, blue) and impactor (m₂, red) with T₂=2 and 3 mm, respectively. By using a DIC (digital image correlation) method, the corresponding displacement field for impactor (m₂) and sample holder (m₁) are experimentally measured. For enhanced displacement resolution, a series of images have been taken by the high-speed cameras for all cases which were recorded with a camera frame rate of 20,000 frames per second.

Interestingly, there is no discontinuous jump of both m₁ and m₂ displacement profiles, which indicates that a hard impact induced by collision between the m₁ and m₂ does not occur regardless of T₂. When x₂(t) or y₂(t)≤dₑ, the engagement of the rubber block with m₂ occurs, which prevents further deformation of the silicone rubber sheet as the m₂ collides with the m₁. Therefore, as shown in FIGS. 7A and 7B, even with higher drop height (h=60 mm), the maximum displacement changes are only 2 (T₂=2 mm) and 3 mm (T₂=3 mm) for m₁ and 2 (T₂=2 mm) and 2.5 mm (T₂=3 mm) for m₂ from the DIC, and 3 (T₂=2 mm) and 4 mm (T₂=3 mm) for m₁ and 2.7 (T₂=2 mm) and 2.9 mm (T₂=3 mm) for m₂ from the simulation (see Movie 1 and Movie 2 for T₂=2 and 3 mm, respectively, frame step=0.5 ms). It is also important to note that during the time interval (0≤t≤0.008 s), there is no phase change such that the governing equation considered in here is phase 1 equation (Eq. (3)). The experimental trend of m₁ and m₂ displacement profiles are matched with those of the simulation, while the deviations between the experiment and simulation results increase as an increase of the m₁ and m₂ displacement change. This is possibly due to strain-dependent non-linear behavior of silicone rubber sheet, soft resilient foam, and rubber block, which are not considered here for simplicity.

To rigorously evaluate the system performance, it is necessary to characterize the impact-induced acceleration profile for a soft gel in the sample holder (m₁). Two different methods are utilized for experimental measurement of the induced acceleration of m₁:1) the use of an accelerometer onto the sample holder and 2) numerical differentiation of the DIC-based displacement measurement in time. For the second approach, spline and fnder function in MATLAB were used for reducing data nosiness and performing interpolation as well as piecewise derivative. The theoretical predication for the m₁ acceleration is quantified by invoking the state vector of m₁ into the corresponding phase equation.

The right plots of FIGS. 7A and 7B indicate the measured and estimated m₁ acceleration profiles (i.e., blue solid line for the accelerometer measurement, black dot for the numerical differentiation of the DIC-based displacement, and blue dotted line for the simulation). First, for repeatedly applying rapid, smooth acceleration profile onto the soft sample, the acceleration of m₁ needs to approach zero (i.e., stationary state) before another impact event happens. Considering the highest motor speed (i.e., 28 rpm), the shortest time scale of respective impact is approximately the second or sub-second time scale. According to FIGS. 7A and 7B, the m₁ accelerations for both T₂ thicknesses return to a stationary state within 0.011 s, which allows the system to continuously and independently inflict a series of impact to the sample. Furthermore, due to an increase of T₂, the stiffness of silicone rubber sheet decreases, leading to a decrease of ω₂, but an increase of the displacement change. Therefore, a lower amplitude of first peak acceleration for larger T₂ (=3 mm) is expected based on the impulse-momentum theorem. To be specific, the extended deformation distance (i.e., displacement change) increases the time over which the change in momentum occurs, resulting in lower acceleration. This hypothesis can be confirmed by similar total impulse amount between two cases (0.491 kg·m/s for T₂=2 mm and 0.451 kg·m/s for T₂=3 mm) during half cycle of the respective acceleration profile (i.e., peak-to-peak time period). Note that the half cycle (i.e., Δtₛ and Δtₑ which denote the time intervals of peak-to-peak acceleration from simulation and experiment, respectively) for T₂=3 mm is longer than that for T₂=3 mm, while the former has lower first peak acceleration value than the latter one, as shown in FIGS. 7A and 7B.

The influence of T₂ on the dynamic characteristics (e.g., displacement and induced acceleration) of the repetitive impact system 100 was investigated. Based on the theoretical and experimental analyses, it was concluded that a smooth, rapid, and consistent acceleration profile, which is important for systematic material characterization, would be accomplished with the developed repetitive impact system 100. Moreover, the impact characteristics of the target sample will be tightly controlled by not only adjustment of drop height but modifying the impact surface.

### Multiple Impact Effect on Soft Gels

Three key results from the experimental and theoretical analyses are 1) smooth and rapid dynamic trajectories of the sample holder, 2) to continuously apply consistent impacts on the sample holder, and 3) a control of the impact characteristics (i.e., acceleration profile) by using different gear types and impact surface conditions. These capabilities achieve versatile applications of the repetitive impact system 100, which befit various simulated situations. Here, the capability of the developed repetitive impact tester is experimentally demonstrated by quantitatively measuring critical acceleration (a_{cr}) associated with the onset of cavitation nucleation in soft materials after several impact with different impact amplitude.

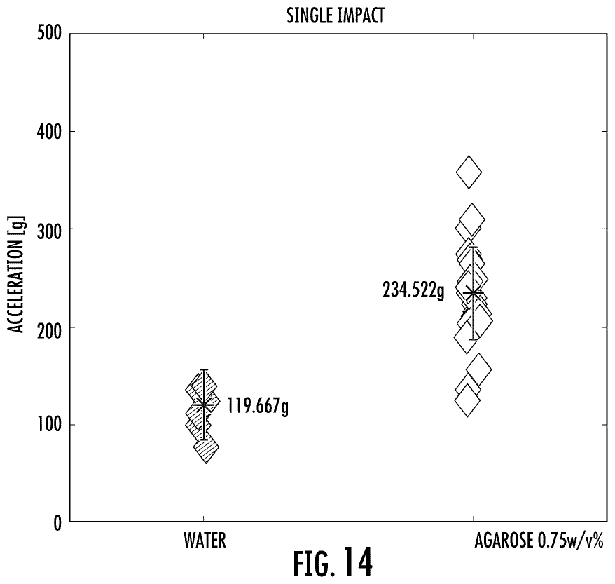

To demonstrate the capability of the repetitive impact system 100 for soft samples, the critical acceleration (a_{cr}) that triggers the onset of cavitation in agarose 0.75 w/v % under repetitive impacts is quantified with different magnitudes, which is controlled by the gear type. Agarose are chosen for demonstration since they are well-used biomaterials as a tissue simulant. Again, the ultimate goal is to characterize soft gel responses (e.g., cavitation) with respect to continuously applied repetitive impacts. Based on the experimental and theoretical results, it is important to point out that the largest peak acceleration magnitude (142.8960 g) from gear type 4 with T₂=2 mm is considerably lower than the der of 14 cm filled agarose 0.75 w/v % in the tube from single impact (234.522 g, see FIG. 14). In this regard, the system 100 is appropriate for characterizing a dynamic mechanical response of soft gel under repetitive impacts (i.e., Total number of applied impacts on individual samples>1) since the cavitation nucleation will not occur with a single drop event.

Detection of Initial Cavitation Nucleation while Applying Repeated Impacts

It is important to know the relation between applied impact characteristics and soft material behaviors. To do so, the first onset of cavitation in a soft gel material subjected to repetitive impacts needs to be timely detected because once cavitation nucleates in the soft material while applying the repetitive impacts, the dynamic response of the material will significantly change and be complicated due to the cavitation collapsed induced localized damage. To overcome this challenge, it is necessary to find a noticeable difference between before and after the onset of cavitation. When a cavitation bubble collapses, it releases a significant amount of energy that can be enough to excite the resonance vibration of the sample holder. This large vibration can lead to high frequency as well as significant amplitude change of the induced acceleration profile. In this regard, the amplified acceleration trajectory will be used to detect the first onset of cavitation while applying repetitive impacts.

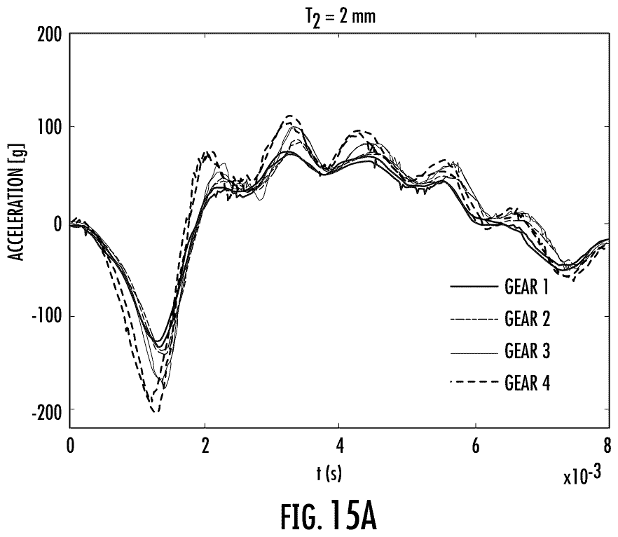

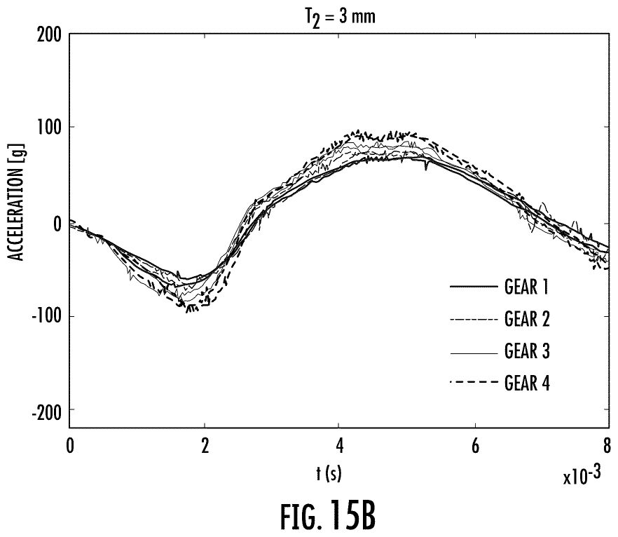

First, an accelerometer 132 is placed on the tube ring in order to clearly identify the amplified acceleration signal by being close to the target sample. Although measured peak acceleration magnitudes on the tube ring are larger than those on the sample holder, both values are still less than the a_{cr} of agarose 0.75 w/v % with single impact for testing a repetitive impact influence on a soft material's response (see FIGS. 15A and 15B). In addition, an accelerometer location closer to the sample provides more accurate acceleration measurements of soft samples as well as better sense of cavitation induced resonance of the material. Next, a threshold of the acceleration signal value along horizontal direction (i.e., perpendicular to impact direction, y-axis) rather than vertical direction (i.e., impact direction, z-axis) is set. This is because the first peak acceleration along the z-axis results from the drop impact event (see z-axis line in FIG. 8), while that for the y-axis comes from the amplified acceleration only caused by the cavitation collapse (y-axis line for the case of “Initial cavitation after 52 impacts” in FIG. 8). In other words, if the detection threshold of the acceleration value along the vertical direction is defined, the data acquisition system 131 will be firstly triggered by the applied continuous impacts, not collapse-induced acceleration change. This indicates that the vertical movement cannot be used as standard for detecting the first cavitation, but a clear difference of the y-axis acceleration amplitude between without or with the cavitation events can be used as a nonvisual signature to trigger the designed algorithm. As already explained above, a specific drop induced acceleration profile is continuously applied onto the sample with the use of specific gear type until the initial cavitation is detected. Once the cavitation collapse induced trigger occurs, the data acquisition system 131 is algorithmized by using SignalExpress software to send a transistor-transistor logic (TTL) pulse to the high-speed camera 134 and then, to save both pre- and post-triggering data and image sets. As a result, the detected acceleration signal is correlated to a series of images from the high-speed camera 134 in time with a particular emphasis on the signature events of the initial cavitation, i.e., nucleation and collapse. Note that during the repetitive impact test, the silicone rubber sheet on top of the sample holder 106 is expected to be gradually degraded as the number of impacts are increased. To avoid any unwanted fluctuation of the impact-induced acceleration profile due to the rubber sheet degradation, the maximum limit of the number of impacts needs to be properly evaluated until a huge maximum acceleration change is observed.

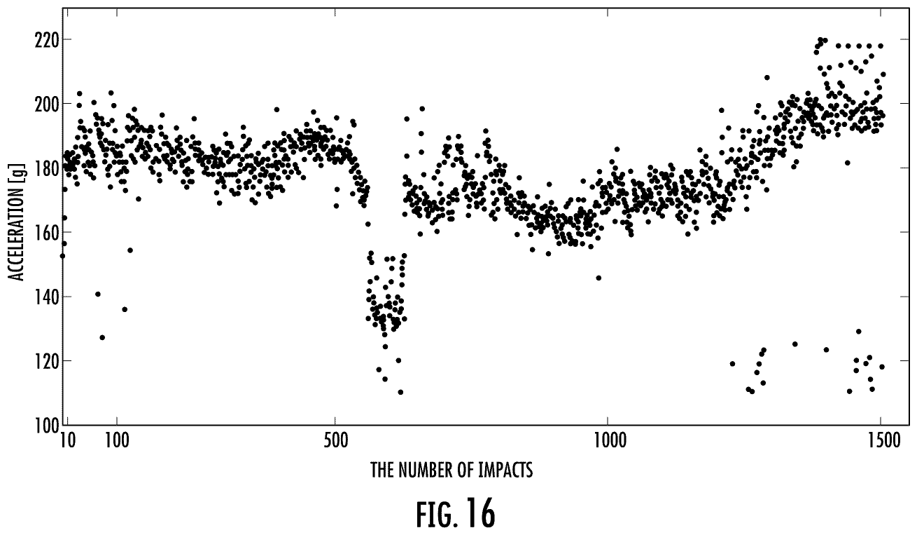

As shown in FIG. 16, significant maximum acceleration amplitude drop happens after 500 impacts such that all samples are only tested until they receive 500 impacts although the cavitation nucleation does not happen in the sample by then.

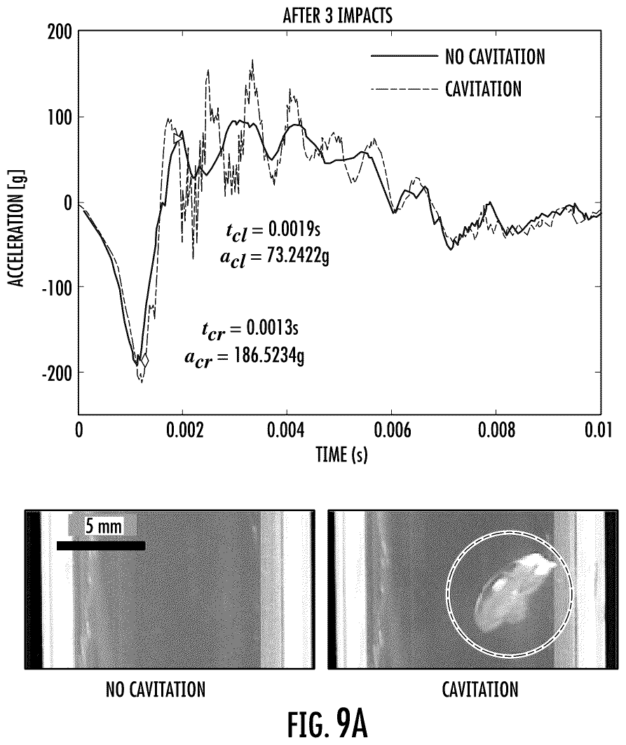

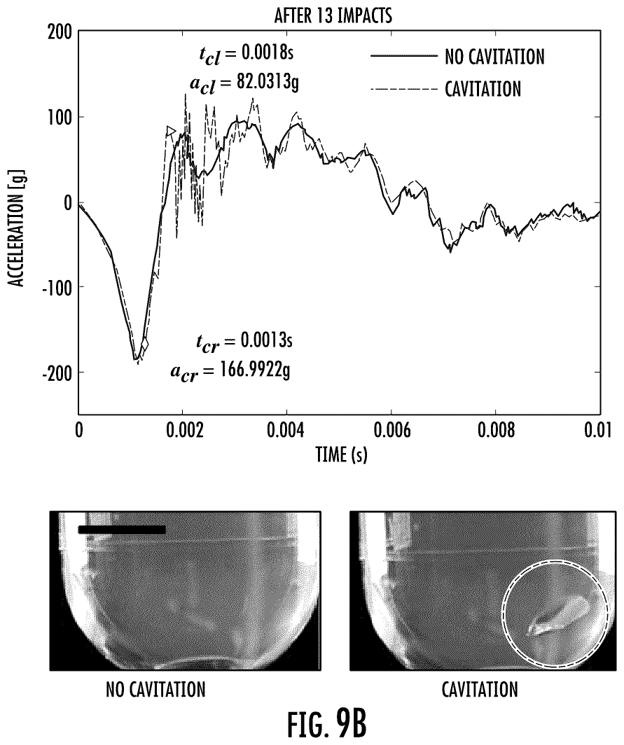

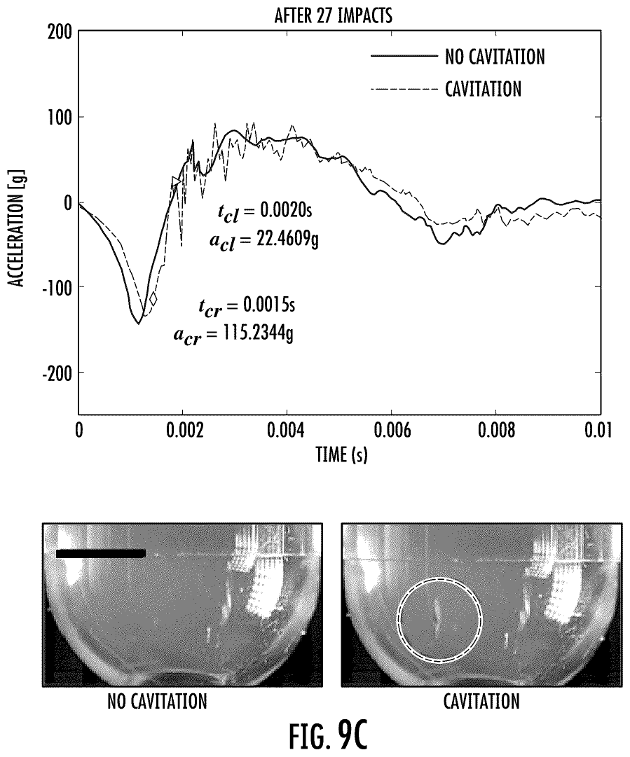

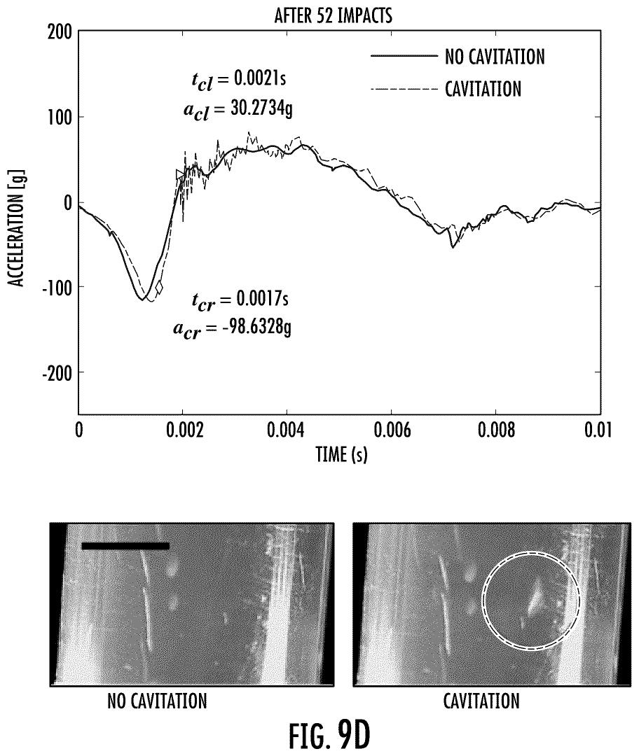

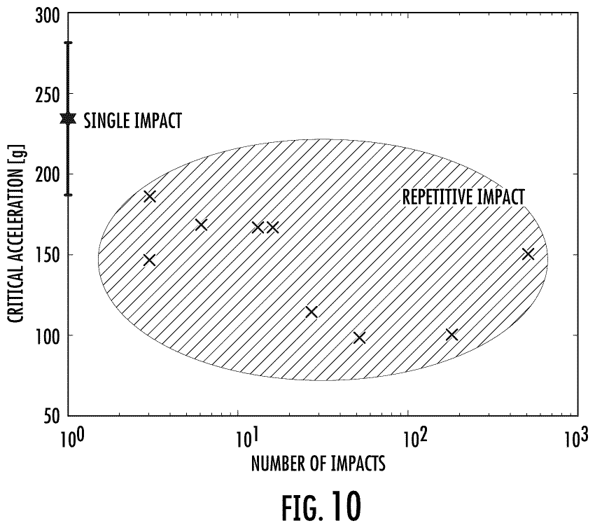

FIG. 9 shows representative experimental results from individual agarose 0.75 w/v % gels with the use of different number of impacts and gear types for nucleating a cavitation event: a) 3 impacts with gear type 3, b) 13 impacts with gear type 3, c) 27 impacts with gear type 1, and d) 52 impacts with gear type 1. As discussed above, cavitation nucleation and collapse events, as denoted by a diamond and a triangle, respectively, are obtained from high-speed camera images. In addition, the corresponding acceleration and time values (i.e., a_{cr}, a_{cl}, t_{cr}, and t_{cl} represent the acceleration and time values for cavitation nucleation and collapse, respectively) are written in each acceleration profile. For visual comparison of the soft sample response between without and with cavitation cases, both high-speed images are attached underneath the corresponding acceleration profile. Note that cavitation nucleation consistently happens during the first trough for all 4 cases.

Three noticeable observations for FIGS. 9A-9D are that 1) the number of impacts to nucleate a cavitation event increases from 3 to 52 with a decrease of input first peak acceleration from to 190.4297 g to 115.2344 g, 2) the magnitude of the a_{cr} significantly decreases for agarose 0.75 w/v % samples from 186.5234 g to 98.6328 g as an increase of the number of impacts, and 3) higher frequency signals are captured after cavitation collapse for every case. The first and second observations indicate the impact characteristics dependent cavitation property. The third observation has been already addressed above through how cavitation collapse is related to the high frequency signals. On top of that, from FIGS. 9A-9D, higher a_{cr} gives rise to a larger cavitation bubble whose major axis length ranges from 2.5 mm (a_{cr}=98.6328 g) to 5.5 mm (a_{cr}=186.5234 g). Presumably, this is due to a larger amount of the acceleration-induced inertial energy, resulting in more significant pressure gradients which lead to the formation of a larger bubble.

The relationship between the critical acceleration (a_{cr}) and the impact number (i.e., the total number of impacts applied until capturing an initial cavitation nucleation) has been considered for agarose 0.75 w/v % as shown in FIG. 10. Interestingly, the a_{cr} values with repetitive impacts (i.e., impact number is greater than 1) are well below the mean a_{cr} (i.e., 234.522 g) with a single impact. For the case of relatively larger impact number (>20), their a_{cr} values are close to the mean a_{cr} of pure water (i.e., 119.667 g, see FIG. 14). Note that with the consideration of system size along an loading direction (i.e., h), the acceleration=induced critical pressure (i.e., p_{cr}=ρa_{cr}h where ρ is a material density) of agarose 0.75 w/v % and pure water with the use of h=14 cm, which height is similar with human brain size, reasonably match with their known values using h=4 cm cuvette in the previous studies (a_{cr}=710 g and 304 g for agarose 0.75 w/v % and water, respectively) One possible implication of these results is that the effect of impact number on the cavitation property is considerable such that cavitation may occur in the brain after receiving significant number of repetitive impacts during contact sports and military operation which upper range of linear acceleration are 120 g and 250 g, respectively.

### DISCUSSION

The impact-induced acceleration trajectories discussed in the present disclosure are closely related to external threats that have been frequently measured during contact sports (e.g., boxing game, ice hockey and American football) and military operation. For example, football players received the head impacts whose mean acceleration is 56 g and upper range is more than 100 g (i.e., a threshold hold of 100 g as a cutoff for detecting possible concussions) during gameplay with a relatively short time scale to peak linear acceleration (a few milliseconds). For the case of firing a shoulder-fired weapon, the mean maximum recoil acceleration ranges from 200 g to 255 g with sub-millisecond time scales. In terms of severe head injuries, not only impact magnitude, but a characteristic time scale of each impact can also be important since brain tissues (e.g., pons, cortex, and cerebellum) are known to have less or minimal energy dissipation rate particularly at the fast strain rate regions (>20 Hz), likely leading to a decrease of impact energy dissipation efficiency to the microstructures. This strain and/or strain-rate dependent material property can provide the reason for why concussive injury mostly occurs at specific impact characteristics (i.e., impacts with accelerations of 100 g or greater and durations of 1-10 milliseconds) of which the impact parameters discussed in the present disclosure are representative.

Another important consideration in the present disclosure is that the mechanical response of agarose 0.75 w/v % sample significantly depends on not only impact amplitude and time scale, but total number of impacts applied on individual samples before the onset of first cavitation. This implies that biomechanical threshold for injury can be impact number dependent. According to injury statistics, individuals with a prior history of TBI are more vulnerable to the following second injury; a player who received substantially lower peak acceleration of the impacts than the cutoff acceleration (<<100 g) was diagnosed with concussions. To be specific, female ice hockey players reported the average peak acceleration (43 g) related with concussive brain juries with three to five successive impacts per day. As an in vivo experiment, a cortical impact study in mice represents a sharp decrease in shear modulus of the damaged brain region which can last for several days. In vitro studies also show that cells result in increased cell damage and degradation of their extracellular matrix (ECM) after a second injury. Although these alternations may not be acute initially, long-lasting changes in biological systems would affect how they react to subsequent mechanical threats in terms of repetitive injuries.

### CONCLUSION

In summary, the unique integrated drop-tower based repetitive impact tester may be used to study mechanical responses of soft materials under smooth, rapid, repeated loading conditions. The newly developed instrument is additionally able to test sample size- and impact characteristics-dependent material properties. The use of a 15 cm long tube for storing biological samples allows for mimicking different sizes of human organs (e.g., kidney, liver, lung and heart) and studying how varying sample sizes affect the mechanical responses of the target soft sample with the same input acceleration profile. Furthermore, the motor system enables continuously applying a well-controlled acceleration profile by changing the type of gear design. More importantly, a novel trigger condition was developed via resonance measurement along orthogonal impact direction, as a non-optical detecting method, to automatically capture the onset of initial cavitation which is one of violent material deformations caused by the rapid mechanical loading. This setup also enables a synchronization of real-time material deformations with the corresponding accelerations.

The critical acceleration corresponding to the cavitation nucleation in agarose 7.5 w/v % gel has been quantified. The present disclosure shows that with a single impact, the critical acceleration for agarose samples in the tube (235 g) is significantly smaller than that for the cuvette in the previous study (800 g). One possible explanation for the lower acceleration threshold for the large tube sample (sample size along impact direction, h=14 cm) compared to the cuvette (h=4 cm) is that the acceleration-induced pressure is linearly proportional to h and, as a result, the critical acceleration associated with cavitation nucleation would significantly decrease with increasing h from 4 to 14 cm. Most notably, the critical acceleration for the agarose sample significantly drops (about a 58% decrease) when the number of impacts prior to the first cavitation nucleation increases from 1 to 52. This result supports others suggesting that soft materials subjected to continuous quasi-static cyclic loading suffer from progressive stress softening behavior resulting from accumulation of inelastic damages such as detachment or breakage of polymer chains and chain slippage.

Many additional implementations are possible. Further implementations are within the CLAIMS.

It will be understood that implementations of the repetitive impact system include but are not limited to the specific components disclosed herein, as virtually any components consistent with the intended operation of various repetitive impact systems may be utilized. Accordingly, for example, it should be understood that, while the drawings and accompanying text show and describe particular repetitive impact system implementations, any such implementation may comprise any shape, size, style, type, model, version, class, grade, measurement, concentration, material, weight, quantity, and/or the like consistent with the intended operation of repetitive impact systems.

The concepts disclosed herein are not limited to the specific repetitive impact systems shown herein. For example, it is specifically contemplated that the components included in particular repetitive impact systems may be formed of any of many different types of materials or combinations that can readily be formed into shaped objects and that are consistent with the intended operation of the repetitive impact systems. For example, the components may be formed of: rubbers (synthetic and/or natural) and/or other like materials; glasses (such as fiberglass), carbon-fiber, aramid-fiber, any combination therefore, and/or other like materials; elastomers and/or other like materials; polymers such as thermoplastics (such as ABS, fluoropolymers, polyacetal, polyamide, polycarbonate, polyethylene, polysulfone, and/or the like, thermosets (such as epoxy, phenolic resin, polyimide, polyurethane, and/or the like), and/or other like materials; plastics and/or other like materials; composites and/or other like materials; metals, such as zinc, magnesium, titanium, copper, iron, steel, carbon steel, alloy steel, tool steel, stainless steel, spring steel, aluminum, and/or other like materials; and/or any combination of the foregoing.

Furthermore, repetitive impact systems may be manufactured separately and then assembled together, or any or all of the components may be manufactured simultaneously and integrally joined with one another. Manufacture of these components separately or simultaneously, as understood by those of ordinary skill in the art, may involve 3-D printing, extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled or removably coupled with one another in any manner, such as with adhesive, a weld, a fastener, any combination thereof, and/or the like for example, depending on, among other considerations, the particular material(s) forming the components.

In places where the description above refers to particular repetitive impact system implementations, it should be readily apparent that a number of modifications may be made without departing from the spirit thereof and that these implementations may be applied to other implementations disclosed or undisclosed. The presently disclosed repetitive impact systems are, therefore, to be considered in all respects as illustrative and not restrictive.

We claim:

1. A repetitive impact system, comprising:
a drop tower having a moveable mass configured to move in a vertical direction with respect to the drop tower;
a sample holder configured to contain a soft material sample, the sample holder positioned in a path of travel of the moveable mass with respect to the drop tower, wherein the sample holder has a foam material and a rubber material layered on both a bottom surface and a top surface of the sample holder; and
a motor system configured to repeatedly lift the moveable mass, the motor system comprising:
a motor configured to rotate at a constant rate;
a rack attached to and configured to move with the moveable mass, wherein the rack has a plurality of teeth; and
a pinion gear attached to the motor, the pinion gear having at least one crescent with at least one tooth, wherein when the motor rotates, the pinion gear rotates such that the at least one crescent circles about the motor, wherein the pinion gear is positioned to allow the at least one tooth of the at least one crescent to interface with the plurality of teeth of the rack when the at least one crescent is closest to the rack, and wherein when the at least one tooth of the at least one crescent interfaces with the plurality of teeth of the rack, the pinion gear is configured to lift the rack and the moveable mass up to a desired height and drop the rack and the moveable mass to impact the sample holder.

2. The repetitive impact system of claim 1, further comprising:
an accelerometer in contact with the sample holder, the accelerometer configured to detect an acceleration value of the sample holder in a horizontal direction perpendicular to the vertical direction; and
a camera configured to take an image of the sample holder in response to detection of the acceleration value of the sample holder rising above a threshold acceleration value.

3. The repetitive impact system of claim 1, wherein the rubber material comprises a silicone rubber sheet.

4. The repetitive impact system of claim 1, wherein the system is configured to apply rapid and smooth acceleration trajectories to the soft material sample.

5. The repetitive impact system of claim 1, wherein the desired height is dependent on a number of teeth in the at least one tooth on the pinion gear.

6. The repetitive impact system of claim 1, wherein the pinion gear is a partial gear.

7. The repetitive impact system of claim 1, wherein the pinion gear is configured to fail before other components of the repetitive impact system.

8. The repetitive impact system of claim 1, wherein the sample holder is aligned with the moveable mass of the drop tower.

9. A repetitive impact system, comprising:
a drop tower having a moveable mass configured to move in a vertical direction with respect to the drop tower;
a sample holder positioned in a path of travel of the moveable mass with respect to the drop tower; and
a motor system configured to repeatedly lift the moveable mass, the motor system comprising:
a motor configured to rotate;
a rack attached to and configured to move with the moveable mass, wherein the rack has a plurality of teeth; and
a pinion gear attached to the motor and positioned to periodically engage with the plurality of teeth of the rack, and wherein when the pinion gear engages with the plurality of teeth of the rack, the pinion gear is configured to lift the rack and the moveable mass up to a desired height and drop the rack and the moveable mass to impact the sample holder.

10. The repetitive impact system of claim 9, wherein the sample holder is configured to contain a soft material sample.

11. The repetitive impact system of claim 9, wherein the sample holder has a foam material and a rubber material layered on at least one of a bottom surface and a top surface of the sample holder.

12. The repetitive impact system of claim 9, wherein the motor rotates at a constant rate.

13. The repetitive impact system of claim 9, wherein the pinion gear has at least one crescent with at least one tooth, wherein when the motor rotates, the pinion gear rotates such that the at least one crescent circles about the motor, and wherein the at least one tooth of the at least one crescent are configured to interface with the plurality of teeth of the rack when the at least one crescent is closest to the rack.

14. The repetitive impact system of claim 9, further comprising:
an accelerometer in contact with the sample holder, the accelerometer configured to detect an acceleration value of the sample holder in a horizontal direction perpendicular to the vertical direction; and
a camera configured to take an image of the sample holder in response to detection of the acceleration value of the sample holder rising above a threshold acceleration value.

15. The repetitive impact system of claim 9, wherein the desired height is dependent on a number of teeth on the pinion gear.

16. A method for detection of initial cavitation nucleation while applying repeated impacts, the method comprising:
providing a sample holder configured to contain a soft material sample;
positioning an accelerometer in contact with the sample holder;
impacting the sample holder repeatedly with a moveable mass moving in a first direction;
selecting a threshold acceleration value for the accelerometer in a second direction perpendicular to the first direction; and
detecting, with the accelerometer, initial cavitation nucleation within the soft material sample by detecting an acceleration value higher than the threshold acceleration value.

17. The method of claim 16, further comprising taking an image of the sample holder with a camera in response to detecting the acceleration with the value higher than the threshold acceleration value.

18. The method of claim 16, further comprising repeatedly lifting the moveable mass with a motor and dropping the moveable mass on the sample holder.

19. The method of claim 18, further comprising providing a pinion gear attached to the motor to lift the moveable mass.

20. The method of claim 19, further comprising configuring the pinion gear to fail before other components involved in the repeated impacts.
